(19) United States
(12) Patent Application Publication
(10) Pub. No.: US 2016/0026820 A1
(43) Pub. Date: Jan. 28, 2016

(54) INFORMATION APPARATUS, MANAGEMENT SERVER, AND COPY CONTROL METHOD

(71) Applicant: Panasonic Intellectual Property Corporation of America, Torrance, CA (US)

(72) Inventors: Masayuki KOZUKA, Osaka (JP); Masaya YAMAMOTO, Kyoto (JP); Kaoru MURASE, Nara (JP); Tadamasa TOMA, Osaka (JP)

(21) Appl. No.: 14/866,234

(22) Filed: Sep. 25, 2015

Related U.S. Application Data
(63) Continuation of application No. PCT/JP2015/000707, filed on Feb. 17, 2015.
(60) Provisional application No. 61/950,394, filed on Mar. 10, 2014.
(60) Provisional application No. 62/046,286, filed on Sep. 5, 2014.

(30) Foreign Application Priority Data
Dec. 24, 2014 (JP) 2014-260005

(51) Int. Cl. G06F 21/62; H04L 29/08; G06Q 50/18

(52) U.S. Cl. CPC G06F 21/6218; G06Q 50/184; H04L 67/06

(57) ABSTRACT

An information recording and playback apparatus includes an input processing unit that obtains a bonus feature obtaining code for requesting permission to copy content data, a playback control unit that reads a content ID from an optical disc, a communication control unit that transmits the bonus feature obtaining code and the content ID to a copy management server and that receives, from the copy management server, a copy permission condition that is associated with a combination of the bonus feature obtaining code and the content ID and that indicates a condition under which content data stored in the optical disc is copied to another recording medium, and a recording control unit that copies the content data stored in the optical disc to the other recording medium in accordance with the copy permission condition.

### BACKGROUND

1. Technical Field

The present disclosure relates to an information apparatus and a copy control method for copying content data stored in a portable recording medium to another recording medium and a management server communicably connected to the information apparatus.

2. Description of the Related Art

As a technique for copying content data stored in a portable recording medium to another recording medium, digital copy or managed copy can be used, but these techniques need to be improved. See, for example, Japanese Unexamined Patent Application Publication No. 2011-254139.

### SUMMARY

One non-limiting and exemplary embodiment provides an information apparatus capable of easily copying content data stored in a portable recording medium to another recording medium.

In one general aspect, the techniques disclosed here feature an information apparatus that copies content data stored in a portable recording medium to another recording medium. The information apparatus includes an obtainer that obtains a permission request code for requesting permission to copy the content data, a reader that reads, from the portable recording medium, content identification information for identifying the content data, the content identification information being stored in the portable recording medium, a transmitter that transmits the permission request code and the content identification information to a management server, a receiver that receives, from the management server, a copy permission condition that is associated with a combination of the permission request code and the content identification information and that indicates a condition under which the content stored in the portable recording medium is copied to the other recording medium, and a copy processor that copies the content data stored in the portable recording medium to the other recording medium in accordance with the copy permission condition.

According to the present disclosure, content data stored in a portable recording medium can be easily copied to another recording medium using a permission request code for requesting permission to copy the content data.

It should be noted that general or specific embodiments may be implemented as a system, a method, an integrated circuit, a computer program, a computer-readable recording medium, or any selective combination thereof. The computer-readable recording medium may be, for example, a nonvolatile recording medium such as a compact disc read-only memory (CD-ROM).

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a diagram illustrating an overall configuration of a copy control system according to a first embodiment of the present disclosure;

FIG. 2 is a diagram illustrating an example of an operational overview of a process for copying content performed in the copy control system according to the first embodiment;

FIG. 3 is a diagram illustrating the structure of Blu-ray data generated by copying data stored in a Blu-ray disc (registered trademark);

FIG. 4 is a flowchart illustrating an example of operations performed by an information recording and playback apparatus and a copy management server according to the first embodiment;

FIG. 5 is a diagram illustrating an example of a bind method selection screen displayed to a user;

FIG. 6 is a flowchart illustrating an example of operations performed by the copy management server and a content provider management server according to the first embodiment;

FIG. 7 is a flowchart illustrating an example of operations performed by the copy management server and the content provider management server according to a modification of the first embodiment;

FIG. 8 is a diagram illustrating an example of an operational overview of a process for copying content performed in a copy control system according to a second embodiment;

FIG. 9 is a diagram illustrating the structure of standard file format (SFF) data generated as a result of an SFF export process;

FIG. 10 is a diagram illustrating an overall configuration of the copy control system according to the second embodiment of the present disclosure;

FIG. 11 is a first flowchart illustrating an example of operations performed by an information recording and playback apparatus and a copy management server according to the second embodiment;

FIG. 12 is a second flowchart illustrating the example of the operations performed by the information recording and playback apparatus and the copy management server according to the second embodiment;

FIG. 13 is a flowchart illustrating an example of operations performed by the information recording and playback apparatus and the copy management server according to a modification of the second embodiment;

FIG. 14 is a diagram illustrating a relationship between an SFF export function and data for export according to a third embodiment;

FIG. 15 is a diagram illustrating the configuration of an SFF conversion unit, which performs the SFF export process;

FIG. 16 is a diagram illustrating an overall configuration of a copy control system according to the third embodiment of the present disclosure;

FIG. 17 is a flowchart illustrating an example of operations performed by an information recording and playback apparatus and a copy management server according to the third embodiment;

FIG. 18 is a first flowchart illustrating an example of operations performed by the information recording and playback apparatus and the copy management server according to a modification of the third embodiment;

FIG. 19 is a second flowchart illustrating the example of the operations performed by the information recording and playback apparatus and the copy management server according to the modification of the third embodiment;

FIG. 20 is a diagram illustrating an overall configuration of a copy control system according to a fourth embodiment of the present disclosure;

FIG. 21 is a flowchart illustrating an example of operations performed by a copy management server and a content provider management server according to the fourth embodiment;

FIG. 22 is a flowchart illustrating an example of operations performed by an information recording and playback apparatus and the content provider management server according to the fourth embodiment;

FIG. 23 is a diagram illustrating an overall configuration of a copy control system according to a fifth embodiment of the present disclosure;

FIG. 24 is a flowchart illustrating an example of operations performed by a copy management server and a content provider management server according to the fifth embodiment;

FIG. 25 is a first flowchart illustrating an example of operations performed by an information recording and playback apparatus, the copy management server, and the content provider management server according to the fifth embodiment;

FIG. 26 is a second flowchart illustrating the example of the operations performed by the information recording and playback apparatus, the copy management server, and the content provider management server according to the fifth embodiment;

FIG. 27 is a diagram illustrating an overall configuration of a copy control system according to a sixth embodiment of the present disclosure;

FIG. 28 is a flowchart illustrating an example of operations performed by an information recording and playback apparatus and a copy management server according to the sixth embodiment;

FIG. 29 is a flowchart illustrating an example of operations performed by the information recording and playback apparatus, the copy management server, and a content provider management server according to the sixth embodiment; and

FIG. 30 is a diagram illustrating a digital copy system in an example of the related art.

### DETAILED DESCRIPTION

### Underlying Knowledge Forming Basis of the Present Disclosure

As a technique for copying content data stored in a portable recording medium to another recording medium, digital copy or managed copy can be used. These two techniques will be described hereinafter in order to clarify improvements made in the present disclosure.

First, the digital copy will be described. As smartphones and tablet computers gain in popularity, image content is increasingly copied to such devices and viewed outdoors. In the United States, a system called “digital copy” is widely used as a service that enables users to copy image content to smartphones and tablet computers. In Japan, too, as a variation of such a system, a service called “e-move (registered trademark)” has been introduced.

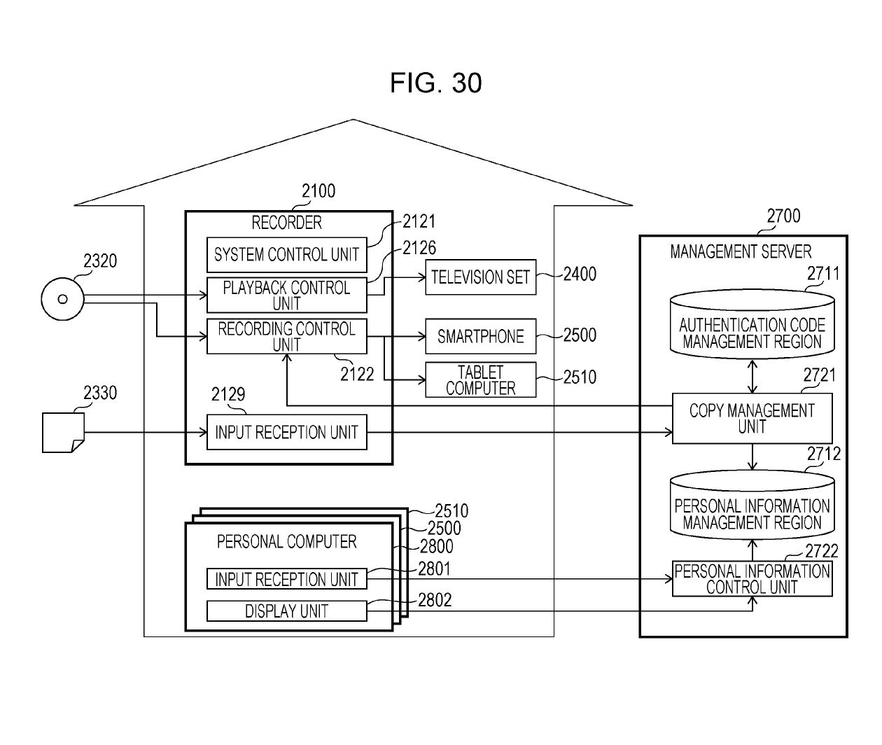

FIG. 30 is a diagram illustrating a digital copy system in an example of the related art. The user purchases a Blu-ray disc 2320 at a store and plays back the Blu-ray disc 2320 on a recorder 2100. In ordinary playback, a playback control unit 2126 reads content from the Blu-ray disc 2320 and performs a process such as decryption. The playback control unit 2126 then plays back the content on a television set 2400.

In a Blu-ray value-added service such as the digital copy, an authentication code 2330 is included in a package of the Blu-ray disc 2320 that the user has purchased. The authentication code 2330 is typically written on an ordinary document and includes about a dozen letters and numbers. When the user desires to copy the content stored in the Blu-ray disc 2320 to a smartphone 2500 or a tablet computer 2510, the user inputs the authentication code 2330, which includes letters and numbers, using, for example, a remote control (not illustrated) of the recorder 2100 or an infrared remote control function of the smartphone 2500. Upon receiving the authentication code 2330, an input reception unit 2129 of the recorder 2100 transmits the received authentication code 2330 to a management server 2700.

A copy management unit 2721 checks use states of authentication codes managed in an authentication code management region 2711. If the received authentication code 2330 is not in use, the copy management unit 2721 permits the recorder 2100 to copy the content. Having been permitted to copy the content, the recorder 2100 reads the content from the Blu-ray disc 2320 and copies the content to the smartphone 2500 or the tablet computer 2510 using a recording control unit 2122.

After the content is copied, a content provider or a service provider might check which user has copied the content. This is because the content provider or the service provider desires to recommend the user past movies in the same genre or promote a newly released movie in accordance with the taste of each user by learning what kind of content each user has purchased and copied.

In the digital copy system illustrated in FIG. 30, therefore, the user inputs in advance personal information such as name, age, mail address, and favorite movie genre using a personal computer (PC) 2800, the smartphone 2500, the tablet computer 2510, or the like. Upon receiving the input personal information, a personal information control unit 2722 of the management server 2700 issues an identifier (ID) for identifying the user and displays the ID on a display unit 2802. The input personal information is accumulated in a personal information management region 2712.

In this case, the input reception unit 2129 also receives the user ID for identifying the user at the same time as receiving the authentication code 2330, which includes about a dozen letters and numbers. The management server 2700 can therefore learn which pieces of image content each user has copied. Information regarding the pieces of content each user has copied is accumulated in the personal information management region 2712.

In the digital copy system in the example of the related art, the management server 2700 is managed by each content provider or service provider. Because there are a plurality of content providers and service providers, however, the recorder 2100 needs to be compatible with a plurality of systems in this management scheme. Because it is extremely difficult to be compatible with all the systems, current recorders are compatible with only a few systems.

In order to avoid this problem, it is preferable that an organization independent of the content providers and the service providers manage the management server 2700. In this case, however, it is difficult for the organization to provide the personal information managed in the personal information management region 2712 for the content providers and the service providers. Data managed by such an organization cannot be provided for the content providers and the service providers without the consent of each user because of laws that protect privacy.

Next, the managed copy will be described. In the above-described digital copy, content different from main content stored in a Blu-ray disc intended to be played back on a recorder is prepared. This content is obtained from the same Blu-ray disc in which the main content is stored or another disc such as a digital versatile disc (DVD) and played back on a smartphone, a tablet computer, a PC, or the like.

On the other hand, in the managed copy, the main content stored in the Blu-ray disc is copied to a hard disk drive (HDD), a solid-state drive (SSD), a medium card such as a secure digital (SD) card, a smartphone, a tablet computer, or the like from the Blu-ray disc as it is or after a format thereof is converted or down-converted and then compressed again. As a result, in the managed copy, the main content can be viewed without a recorder.

Technical aspects of the managed copy are described in “Advanced Access Content System (AACS) Blu-ray Disc Pre-recorded Book, Revision 0.952, Final, Jul. 14, 2011”. In the book, details of a method for realizing the managed copy specified in the AACS, which is a technique for protecting copyright in a current Blu-ray format, are described.

As a basic concept of the managed copy, copying can be performed using a copyright protection technique specified in the AACS after an owner of copyright approves the copying. At this time, a user pays money specified by the owner of copyright. In a managed copy system, therefore, a certain charging process needs to be performed. Although specifications of the copyright protection technique are strict, a file may be copied as it is, part of the file may be copied, or an image subjected to Moving Picture Experts Group (MPEG) compression may be decrypted and down-converted and then compressed again. A process for performing the managed copy is therefore complex, and it takes long time to compress content again. Managed copy is thus not advantageous compared to the digital copy, in which content is downloaded through a network.

The digital copy might become popular among PCs, which copy content through the network, but it is difficult to perform the digital copy using consumer appliances.

In addition, in the digital copy, low-image-quality content different from a movie (main content) stored in a Blu-ray disc needs to be prepared.

In addition, in the digital copy, consumer information can be obtained through the network, but each provider needs to manage a management server, and it is difficult for a plurality of providers to manage customer information using the same management server or the like.

It is difficult to realize the managed copy using consumer appliances since a charging process needs to be performed. Although PCs can realize the managed copy, most PCs do not include a Blu-ray drive.

In addition, in the managed copy, image quality and a transfer rate are high if content stored in a Blu-ray disc is copied as it is. If content is transferred after image quality is reduced to reduce the amount of data, the transfer rate is extremely low. It is therefore more convenient to copy content through the network by performing the digital copy.

In addition, since a management server used for the managed copy needs to perform a charging process, the management server can collect customer information, but because the process becomes more complex, collection of customer process is not specified.

The following are two reasons why owners of copyright permit users to legally copy content stored in Blu-ray discs to recording servers such as Blu-ray recorders and mobile devices such as smartphones and tablet computers and view the content without using the Blu-ray discs.

First, smartphones and tablet computers have gained in popularity and replaced laptop PCs and mobile DVD players as principal mobile devices used for viewing image content. Movie distribution services intended for these mobile devices are now widely available. Blu-ray discs, as a package medium, can satisfy users' desire to possess content and are suitable for users who view highest quality images on large screens, but are not suitable for users who desire to store content in smartphones or tablet computers and view the content in various places. In order to sell more Blu-ray discs, Blu-ray discs need to satisfy both types of users. Through the digital copy or the managed copy, it is possible to satisfy the users who view content on mobile devices.

Second, it has become common to apply big data processing of customer information to marketing, and online stores are increasing sales by securing customers through a function of introducing content in accordance with purchase histories of the customers. In particular, image content can be sold not only through package media such as Blu-ray discs and DVDs but also through digital image distribution services. The customers' purchase histories of Blu-ray discs and DVDs can therefore be used for effective introduction to video-on-demand (VOD) services and flat-rate image distribution services as well as recommendation of package media, which poses a threat to owners of the copyright of image content. If, therefore, a right to perform the digital copy or the managed copy is given to a customer when the customer purchases a package medium such as a Blu-ray disc, a content provider can lead the customer to an online digital content store thereof through the package medium. In addition, customer information can be obtained by making it mandatory for the customer to input customer information to get the right to perform the digital copy or the managed copy.

Due to the above two reasons, image content providers have stopped banning copying and begun to provide the digital copy or the managed copy. The digital copy and the managed copy, however, have their respective disadvantages as described hereinafter, and are not popular in countries other than the United States, including Japan.

In the digital copy, when content is stored in Blu-ray discs, it is difficult to store content localized for each country in Blu-ray discs commonly used in a plurality of countries. As a result, it is difficult to conduct promotion in accordance with a situation of each country. If DVDs are distributed, it is possible to conduct unique promotion for each country, but manufacturing cost increases. If a right to download content is given to a customer who has purchased a Blu-ray disc, there are no disadvantages like those of Blu-ray discs and DVDs described above. Each movie company, however, needs to manage a web server in order to distribute digital content, which increases cost.

In addition, it undesirably takes significantly longer time to obtain content through a network than to transfer content to an HDD, a mobile device, or a medium card from a Blu-ray disc or a DVD. In addition, an image (a bonus feature image or a movie image whose image quality is lower) different from main content stored in a Blu-ray disc is provided. The image quality of the content that can be copied might be sufficient for a user who views the content on a mobile device, but might be insufficient compared to that of the Blu-ray disc if a user views the content on a large screen.

The managed copy is a technique developed to make up for the disadvantages of the digital copy. In the managed copy, main content stored in a Blu-ray disc can be copied without reducing image quality or can be viewed on a mobile device after data size is reduced without reducing image quality. Since main content stored in a Blu-ray disc can be copied as it is or after image quality is reduced, content different from the main content need not be prepared in the Blu-ray disc, a DVD, or a network. The managed copy is expected to overcome the disadvantages of the digital copy.

The managed copy currently specified by the AACS, however, has a significant problem that a charging process and the like need to be performed, and it is difficult to solve this problem. As of February 2014, the managed copy is not in operation. As described above, since an apparatus that performs the managed copy, a server that manages the managed copy, a content production company, and a charging process are closely related to one another, the server needs to perform a complex process for the managed copy.

Since the content production company does not own the server, it is difficult for the content production company to conduct appropriate promotion for each piece of content in a timely manner. Although software installed on a PC can realize a managed copy machine, it is difficult to perform a charging process if a managed copy machine is realized by a consumer appliance. In addition, it is difficult for a consumer appliance to perform a plurality of charging processes and respond to complex desires of the content production company. For these reasons, although a standard has been established, services have not started.

An information apparatus according to an aspect of the present disclosure is an information apparatus that copies content data stored in a portable recording medium to another recording medium. The information apparatus includes an obtainer that obtains a permission request code for requesting permission to copy the content data, a reader that reads, from the portable recording medium, content identification information for identifying the content data, the content identification information being stored in the portable recording medium, a transmitter that transmits the permission request code and the content identification information to a management server, a receiver that receives, from the management server, a copy permission condition that is associated with a combination of the permission request code and the content identification information and that indicates a condition under which the content stored in the portable recording medium is copied to the other recording medium, and a copy processor that copies the content data stored in the portable recording medium to the other recording medium in accordance with the copy permission condition.

According to this configuration, the permission request code for requesting permission to copy the content data is obtained. The content identification information for identifying the content data, the content identification information being stored in the portable recording medium, is read from the portable recording medium. The permission request code and the content identification information are transmitted to the management server. The copy permission condition that is associated with the combination of the permission request code and the content identification information and that indicates the condition under which the content data stored in the portable recording medium is copied to the other recording medium is received from the management server. The content data stored in the portable recording medium is copied to the other recoding medium in accordance with the copy permission condition.

The content data stored in the portable recording medium can thus be easily copied to the other recording medium using the permission request code for requesting permission to copy the content data.

In the information apparatus, for example, the obtainer may receive user identification information for identifying a user and obtain the received user identification information as the permission request code.

According to this configuration, since the user identification information for identifying the user is received and the received user identification information is obtained as the permission request code, the content data stored in the portable recording medium can be easily copied to the other recording medium. In addition, by registering the user identification information to the information apparatus, the user identification information need not be input in each copying operation, and the content data stored in the portable recording medium can be copied to the other recording medium more easily.

In the information apparatus, for example, the copy permission condition may include a condition that a file format of content data obtained as a result of copying be selected from a plurality of predetermined file formats. The copy processor may receive one of the plurality of file formats selected by the user and copy the content data in the received file format.

According to this configuration, the copy permission condition includes the condition that the file format of the content data obtained as a result of the copying be selected from the plurality of predetermined file formats. One of the plurality of file formats selected by the user is then received, and the content data is copied in the received file format.

Since the content provider can determine the file format of the content data obtained as a result of the copying, the content provider can change the image quality of the content data obtained as a result of the copying and the length of processing time taken to convert the file format.

In the information apparatus, for example, the plurality of file formats may include a transport stream format and an MP4 format.

According to this configuration, either the transport stream format or the MP4 format can be selected as the file format. That is, an optimal file format can be selected in accordance with the image quality of the content data obtained as a result of the copying and the apparatus that plays back the content data obtained as a result of the copying.

In the above information apparatus, for example, the copy permission condition may include a first condition under which only copying to a certain device is permitted, a second condition under which only copying to a certain type of recording medium is permitted, and a third condition under which only copying to a certain domain in a network is permitted. The copy processor may receive the first condition, the second condition, or the third condition selected by the user and copy the content data under the first condition, the second condition, or the third condition selected by the user.

According to this configuration, the copy permission condition includes the first condition under which only copying to a certain device is permitted, the second condition under which only copying to a certain type of recording medium is permitted, and the third condition under which only copying to a certain domain in a network is permitted. The copy processor receives the first condition, the second condition, or the third condition selected by the user and copies the content data under the first condition, the second condition, or the third condition selected by the user.

The content provider can therefore determine a copy destination of the content data and permit only a copy destination that adopts a copyright protection method desired thereby to copy the content data.

In the information apparatus, for example, the copy processor may receive a bind method selected by the user and copies the content data using the bind method. The bind method may be a device bind method in which only copying to a certain device is permitted, a media bind method in which only copying to a certain type of recording medium is permitted, or a domain bind method in which only copying to a certain domain in a network is permitted. The transmitter may transmit a result of copying of the content data performed by the copy processor. The result of the copying may include information indicating the bind method used by the copy processor for copying the content data.

A management server according to another aspect of the present disclosure is a management server communicably connected to an information apparatus that copies content data stored in a portable recording medium to another recording medium. The management server includes a copy permission condition storage used for storing a combination of content identification information for identifying the content data and a permission request code for requesting permission to copy the content data and a copy permission condition indicating a condition under which the content data stored in the portable recording medium is copied to the other recording medium, the combination and the copy permission condition being associated with each other, a receiver that receives the permission request code and the content identification information from the information apparatus, a reader that reads, from the copy permission condition storage, the copy permission condition associated with the combination of the permission request code and the content identification information received from the information apparatus, and a transmitter that transmits the read copy permission condition to the information apparatus.

According to this configuration, the combination of the content identification information for identifying the content data and the permission request code for requesting permission to copy the content data and the copy permission condition indicating the condition under which the content data stored in the portable recording medium is copied to the other recording medium, the combination and the copy permission condition being associated with each other, are stored in the copy permission condition storage. The permission request code and the content identification information are received from the information apparatus. The copy permission condition associated with the combination of the permission request code and the content identification information received from the information apparatus is read from the copy permission condition storage. The read copy permission condition is transmitted to the information apparatus.

The content data stored in the portable recording medium can therefore be easily copied to the other recording medium using the permission request code for requesting permission to copy the content data.

In the management server, for example, the permission request code may include user identification information for identifying a user.

According to this configuration, after the user identification information is input, the content data stored in the portable recording medium can be easily copied to the other recording medium. In addition, by registering the user identification information to the information apparatus, the user identification information need not be input in each copying operation, and the content data stored in the portable recording medium can be copied to the other recording medium more easily.

The management server may further include, for example, a generator that generates the permission request code managed in association with the content identification information, a permission request code register that registers the generated permission request code to the copy permission condition storage, and a provider that provides the permission request code and the content identification information for a server managed by a content provider that manufactures the portable recording medium.

According to this configuration, the permission request code managed in association with the content identification information is generated. The generated permission request code is registered to the copy permission condition storage. The permission request code and the content identification information are provided for the server managed by the content provider that manufactures the portable recording medium.

Since the management server generates and manages the permission request code, the content provider need not manage the permission request code. Even a small content provider can therefore use this copy function.

The management server may further include, for example, an obtainer that obtains the combination of the content identification information and the user identification information and the copy permission condition associated with the combination from the server managed by the content provider that manufactures the portable recording medium, and a copy permission condition register that registers, to the copy permission condition storage, the content identification information, the user identification information, and the copy permission condition obtained by the obtainer.

According to this configuration, the combination of the content identification information and the user identification information and the copy permission condition associated with the combination are obtained from the server managed by the content provider that manufactures the portable recording medium. The content identification information, the user identification information, and the copy permission condition obtained by the obtainer are registered to the copy permission condition storage.

The content data stored in the portable recording medium can be easily copied to the other recording medium using the user identification information for identifying the user.

The management server may further include, for example, a result receiver that receives, from the information apparatus that has transmitted the copy permission condition, a copy result including information indicating a bind method used for copying the content data, and an abnormality transmitter that notifies the information apparatus of an abnormality if the bind method indicated by the received information is not permitted by the copy permission condition associated with the combination of the permission request code and the content identification information.

A copy control method according to another aspect of the present disclosure is a copy control method for copying content data stored in a portable recording medium to another recording medium. The copy control method includes obtaining a permission request code for requesting permission to copy the content data, reading, from the portable recording medium, content identification information for identifying the content data, the content identification information being stored in the portable recording medium, transmitting the permission request code and the content identification information to a management server, receiving, from the management server, a copy permission condition that is associated with a combination of the permission request code and the content identification information and that indicates a condition under which the content stored in the portable recording medium is copied to the other recording medium, and copying the content data stored in the portable recording medium to the other recording medium in accordance with the copy permission condition.

According to this configuration, the permission request code for requesting permission to copy the content data is obtained. The content identification information for identifying the content data, the content identification information being stored in the portable recording medium, is read from the portable recording medium. The permission request code and the content identification information are transmitted to the management server. The copy permission condition that is associated with the combination of the permission request code and the content identification information and that indicates the condition under which the content stored in the portable recording medium is copied to the other recording medium is received from the management server. The content data stored in the portable recording medium is copied to the other recording medium in accordance with the copy permission condition.

The content data stored in the portable recording medium can therefore be easily copied to the other recording medium using the permission request code for requesting permission to copy the content data.

In the copy control method, for example, in the obtaining, user identification information for identifying a user may be received, and the received user identification information may be obtained as the permission request code.

According to this configuration, since the user identification information for identifying the user is received and the received user identification information is obtained as the permission request code, the content data stored in the portable recording medium can be easily copied to the other recording medium. In addition, by registering the user identification information to the information apparatus, the user identification information need not be input in each copying operation, and the content data stored in the portable recording medium can be copied to the other recording medium more easily.

In the copy control method, for example, the copy permission condition may include a condition that a file format of content data obtained as a result of copying be selected from a plurality of predetermined file formats. In the copying, one of the plurality of file formats selected by the user may be received, and the content data may be copied in the received file format.

According to this configuration, the copy permission condition includes the condition that the file format of content data obtained as a result of copying be selected from the plurality of predetermined file formats. In the copying, one of the plurality of file formats selected by the user is received, and the content data is copied in the received file format.

Since the content provider can determine the file format of the content data obtained as a result of the copying, the content provider can change the image quality of the content data obtained as a result of the copying and the length of processing time taken to convert the file format.

In the copy control method, for example, the plurality of file formats may include a transport stream format and an MP4 format.

According to this configuration, either the transport stream format or the MP4 format can be selected as the file format. That is, an optimal file format can be selected in accordance with the image quality of the content data obtained as a result of the copying and the apparatus that plays back the content data obtained as a result of the copying.

In the copy control method, for example, the copy permission condition may include the first condition under which only copying to a certain device is permitted, the second condition under which only copying to a certain type of recording medium is permitted, and the third condition under which only copying to a certain domain in a network is permitted. In the copying, the first condition, the second condition, or the third condition selected by the user may be received, and the content data may be copied under the first condition, the second condition, or the third condition selected by the user.

According to this configuration, the copy permission condition includes the first condition under which only copying to a certain device is permitted, the second condition under which only copying to a certain type of recording medium is permitted, and the third condition under which only copying to a certain domain in a network is permitted. The copy processor receives the first condition, the second condition, or the third condition selected by the user and copies the content data under the first condition, the second condition, or the third condition selected by the user.

The content provider can therefore determine a copy destination of the content data and permit only a copy destination that adopts a copyright protection method desired thereby to copy the content data.

The present disclosure easily realizes an environment in which ultra-high-quality image content stored in a Blu-ray disc is stored in a Blu-ray recorder at home or a home server and viewed outdoors on a smartphone, a tablet computer, or the like through a combination of an information recording and playback apparatus and a copy management server that can be connected to each other through a network.

A Blu-ray apparatus connects a Blu-ray drive to an internal HDD, a portable HDD, a medium card such as an SD card, a smartphone, or a tablet computer. The Blu-ray apparatus includes a universal serial bus (USB) terminal or Wi-Fi (registered trademark) for storing content read from a Blu-ray disc. The Blu-ray apparatus includes means for inputting a bonus feature obtaining code or a user ID (user identification information), means for reading a content ID (content identification information) stored in the Blu-ray disc, and means for reading an apparatus ID (apparatus identification information). The Blu-ray apparatus transmits the content ID, the apparatus ID, and the bonus feature obtaining code or the user ID to a copy management server, receives a copy permission condition from the copy management server, displays the received copy permission condition to a user, asks the user to select a file format (a Blu-ray data format, a standard file format (SFF), or the like) of a copy of content data, digital rights management (DRM), and a device, and copies the content data from the Blu-ray disc in accordance with the selection of the user.

The copy management server registers combinations of content IDs and bonus feature obtaining codes and copy permission conditions (the number of copies, a file format of a copy, DRM, a digital retailer, or the like) to a bonus feature obtaining code management database and manages the bonus feature obtaining code management database.

The copy management server can respond to an inquiry (the content ID, the apparatus ID, and the bonus feature obtaining code or the user ID) from the Blu-ray apparatus using the bonus feature obtaining code management database, eliminate inappropriate apparatuses, and permit the Blu-ray apparatus to copy content data under appropriate conditions. Moreover, the copy management server can learn which piece of content a user of a certain apparatus has copied, without directly managing personal information.

A content provider management server can sell a function of copying content data through various charging processes under various sale conditions by managing only copy permission conditions associated with combinations of content IDs and bonus feature obtaining codes stored in the copy management server or copy permission conditions associated with combinations of content IDs and user IDs.

The digital retailer can sell a right to copy content data like ordinary digital content if the digital retailer has obtained, from a content provider, permission to sell a function of copying the content data.

Embodiments of the present disclosure will be described hereinafter with reference to the accompanying drawings. The following embodiments are specific examples of the present disclosure and do not limit the technical scope of the present disclosure.

### First Embodiment

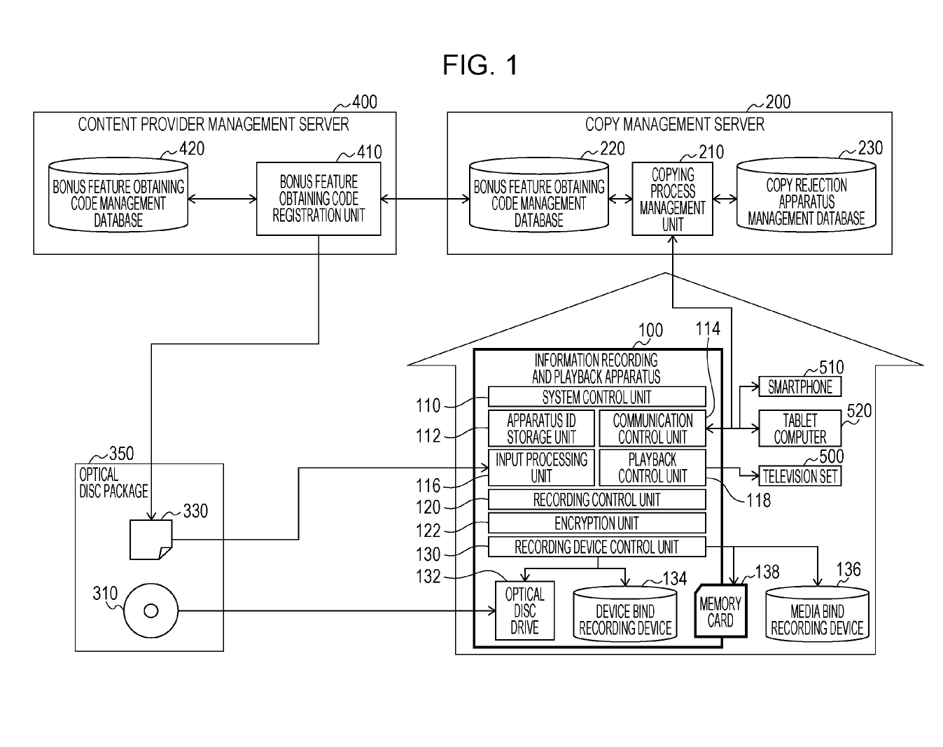

FIG. 1 is a diagram illustrating an overall configuration of a copy control system according to a first embodiment of the present disclosure.

The copy control system illustrated in FIG. 1 includes an information recording and playback apparatus 100, a copy management server 200, a content provider management server 400, a television set 500, and a smartphone 510.

The information recording and playback apparatus 100 includes a system control unit 110, an apparatus ID storage unit 112, a communication control unit 114, an input processing unit 116, a playback control unit 118, a recording control unit 120, an encryption unit 122, a recording device control unit 130, an optical disc drive 132, and a device bind recording device 134.

The system control unit 110 controls the entirety of the information recording and playback apparatus 100. The apparatus ID storage unit 112 is used for storing an apparatus ID for identifying the information recording and playback apparatus 100. The communication control unit 114 controls communication with the copy management server 200 as well as communication with mobile devices such as the smartphone 510 and a tablet computer 520. The input processing unit 116 receives a bonus feature obtaining code 330 for requesting permission to copy content data stored in an optical disc 310. The input processing unit 116 then obtains the bonus feature obtaining code 330.

The playback control unit 118 plays back the content data stored in the optical disc 310 and transmits image signals to a display device such as the television set 500. Although the optical disc 310 according to the present embodiment is a Blu-ray disc, the optical disc 310 is not limited to this. The optical disc 310 may be any portable recording medium such as a compact disc (CD) or a DVD, instead. The optical disc 310 is used for storing a content ID for identifying the content data, and the playback control unit 118 reads the content ID from the optical disc 310.

The recording control unit 120 records the content data read from the optical disc 310 on another recording medium. The encryption unit 122 encrypts the content data. The recording device control unit 130 controls the optical disc drive 132 and the device bind recording device 134. The device bind recording device 134 is, for example, an HDD. If a media bind recording device 136 and a memory card 138 are connected to the information recording and playback apparatus 100, the recording device control unit 130 controls the media bind recording device 136 and the memory card 138. The media bind recording device 136 is, for example, an external HDD. The memory card 138 is, for example, a SD memory card.

The communication control unit 114 transmits the apparatus ID, the bonus feature obtaining code 330, and the content ID to the copy management server 200. Alternatively, the communication control unit 114 may transmit only the bonus feature obtaining code 330 and the content ID. The communication control unit 114 receives, from the copy management server 200, a copy permission condition indicating a condition under which the content data stored in the optical disc 310 can be copied to another recording medium. The copy permission condition is associated with a combination of the bonus feature obtaining code 330 and the content ID.

The recording control unit 120 copies the content data stored in the optical disc 310 to another recording medium in accordance with the copy permission condition.

If a user inserts the optical disc 310 into the optical disc drive 132, selects a function of copying the content data stored in the optical disc 310 to another recording medium, and inputs the bonus feature obtaining code 330, the recording control unit 120 transmits a copy permission request to the copy management server 200 to request permission to copy the content data. The copy permission request includes the bonus feature obtaining code 330, the content ID, and the apparatus ID. The recording control unit 120 obtains the copy permission condition received from the copy management server 200, displays the obtained copy permission condition to the user, asks the user to select at least a file format (the Blu-ray data format, the SFF, or the like) of a copy of the content data, a bind method, or a copy destination, and copies the content data in accordance with the selection.

The copy permission condition includes a first condition (device bind) under which only copying to a certain device is permitted, a second condition (media bind) under which only copying to a certain type of recording medium is permitted, and a third condition (domain bind) under which only copying to a certain domain in a network is permitted. The recording control unit 120 receives the first condition, the second condition, or the third condition selected by the user and copies the content data under the selected condition.

The copy management server 200 includes a copying process management unit 210, a bonus feature obtaining code management database 220, and a copy rejection apparatus management database 230.

The copying process management unit 210 associates combinations of content IDs and bonus feature obtaining codes and copy permission conditions with each other and registers the combinations and the copy permission conditions to the bonus feature obtaining code management database 220 in accordance with a request from the content provider management server 400. Each copy permission condition includes, for example, at least the number of copies, the file format of content data, the bind method, the copy destination such as a digital retailer, or the like. The copying process management unit 210 manages the bonus feature obtaining code management database 220.

The copy rejection apparatus management database 230 is used for storing apparatus IDs of apparatuses that are not permitted to copy content data.

The copying process management unit 210 checks, in accordance with a request (the content ID, the apparatus ID, and the bonus feature obtaining code 330) from the information recording and playback apparatus 100, that the received apparatus ID is not registered in the copy rejection apparatus management database 230, in which the apparatus IDs of the inappropriate apparatuses are stored. An inappropriate apparatus is thus prevented from copying content data.

The copying process management unit 210 checks that the received combination of the content ID and the bonus feature obtaining code 330 is stored in the bonus feature obtaining code management database 220. The copying process management unit 210 then obtains the copy permission condition associated with the received content ID and transmits the obtained copy permission condition to the information recording and playback apparatus 100.

The copying process management unit 210 may generate permission request codes managed in association with the content IDs. The copying process management unit 210 may register the generated permission request codes to the bonus feature obtaining code management database 220. The copying process management unit 210 may provide (transmit) the permission request codes and the content IDs for a server managed by a content provider that manufactures optical discs (portable recording media).

The content provider management server 400 includes a bonus feature obtaining code registration unit 410 and a bonus feature obtaining code management database 420.

The content provider management server 400 manages the combinations of the content IDs and the bonus feature obtaining codes or the combinations of the content IDs and the user IDs in the copy management server 200 and the copy permission conditions associated with the content IDs to enable a content provider to sale a function of copying content data through various charging systems under various sale conditions.

Copy histories managed by the bonus feature obtaining code management database 220 are provided for the content provider management server 400, and the content provider can learn how each user has copied each piece of content. Because a plurality of content providers use the same copy management server 200 in the present embodiment, the plurality of content providers can share information. In general, however, content providers compete among themselves, and information regarding copying of content owned by a certain content provider is preferably provided only for the content provider. Information regarding content owned by another content provider can nevertheless be provided by statistically processing the information. Information regarding a title of content copied by a certain user, for example, may not be provided, but information regarding a favorite genre (for example, animation, comedy, or the like) of the user might be provided. In this case, the tastes of users who copy a certain type of content can be identified.

The bonus feature obtaining code management database 420 is used for storing the combinations of the content IDs and the bonus feature obtaining codes.

The bonus feature obtaining code registration unit 410 registers the combinations of the content IDs and the bonus feature obtaining codes to the bonus feature obtaining code management database 420. Alternatively, the bonus feature obtaining code registration unit 410 may generate content IDs and bonus feature obtaining codes and register combinations of the generated content IDs and bonus feature obtaining codes to the bonus feature obtaining code management database 420. Alternatively, the bonus feature obtaining code registration unit 410 may receive content IDs and bonus feature obtaining codes and register combinations of the received content IDs and bonus feature obtaining codes to the bonus feature obtaining code management database 420. Alternatively, the bonus feature obtaining code registration unit 410 may receive content IDs and bonus feature obtaining codes transmitted from the copy management server 200 and register combinations of the received content IDs and bonus feature obtaining codes to the bonus feature obtaining code management database 420.

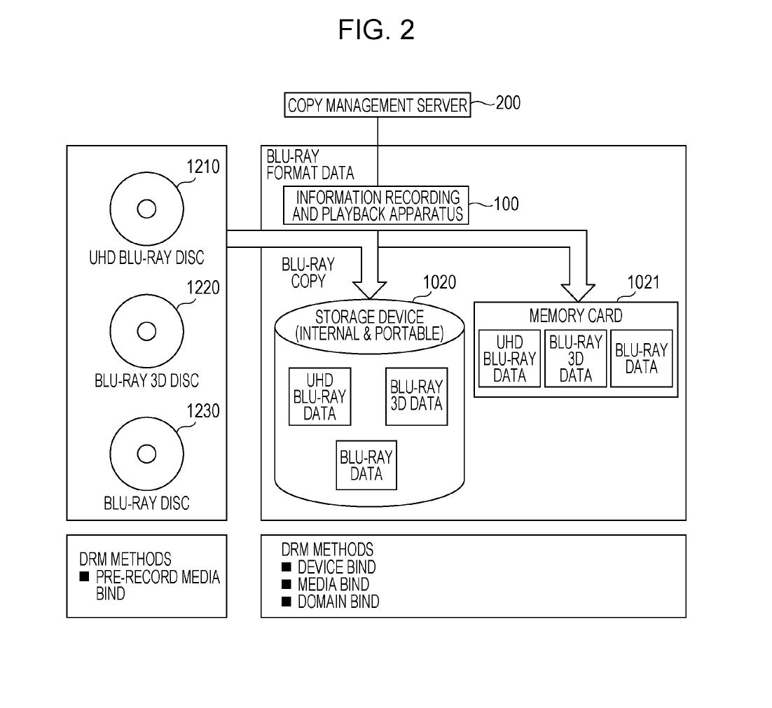

FIG. 2 is a diagram illustrating an example of an operational overview of a process for copying content performed in the copy control system according to the first embodiment.

When the copy control system copies content data stored in a Blu-ray disc, the copy control system does not change a data format of the content data and stores the content data in a storage device 1020 such as an HDD or a memory card 1021 such as an SD memory card. The copy control system copies content data stored in a Blu-ray disc 1230 currently in use (full high-definition (HD) image quality or Advanced Video Coding (AVC) compression), a Blu-ray 3D (registered trademark) disc 1220 (full HD 3D image quality or Multiview Video Coding (MVC) compression), or an Ultra HD Blu-ray (registered trademark) disc 1210 (ultra-high-definition (UHD) image quality or High Efficiency Video Coding (HEVC) compression). The bind method used may be device bind, media bind, or domain bind.

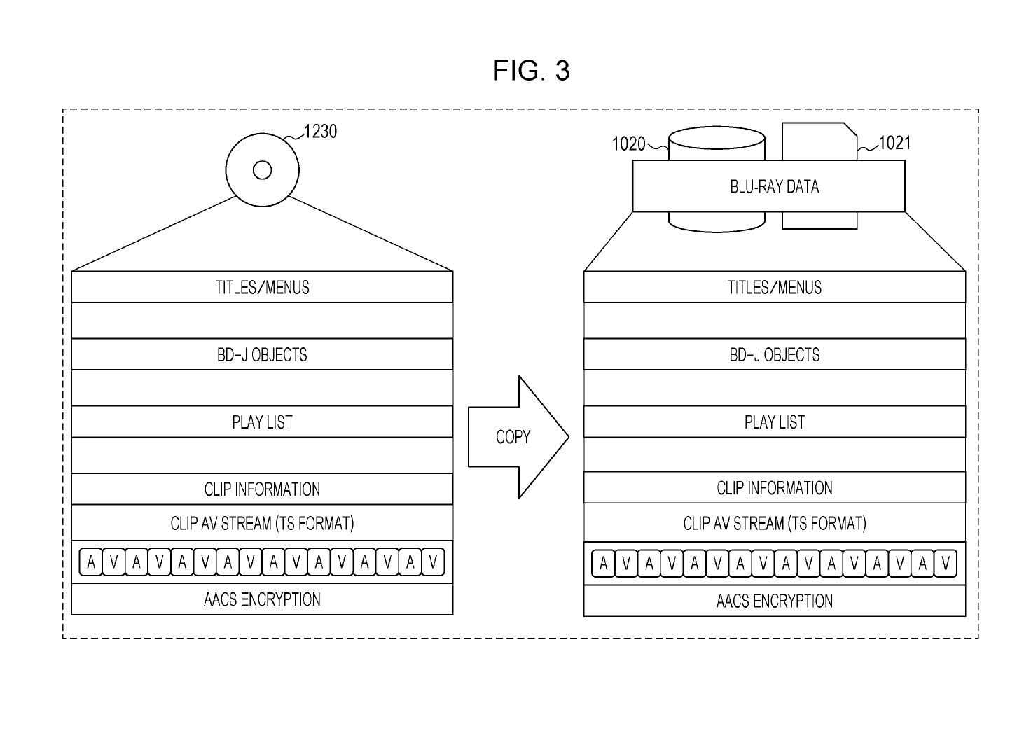

FIG. 3 is a diagram illustrating the structure of Blu-ray data generated by copying data stored in the Blu-ray disc 1230. As illustrated in FIG. 3, all functions of the Blu-ray disc 1230 are copied to the storage device 1020 or the memory card 1021. The image quality and operability of the data obtained as a result of the copying are the same as those of the data stored in the Blu-ray disc 1230.

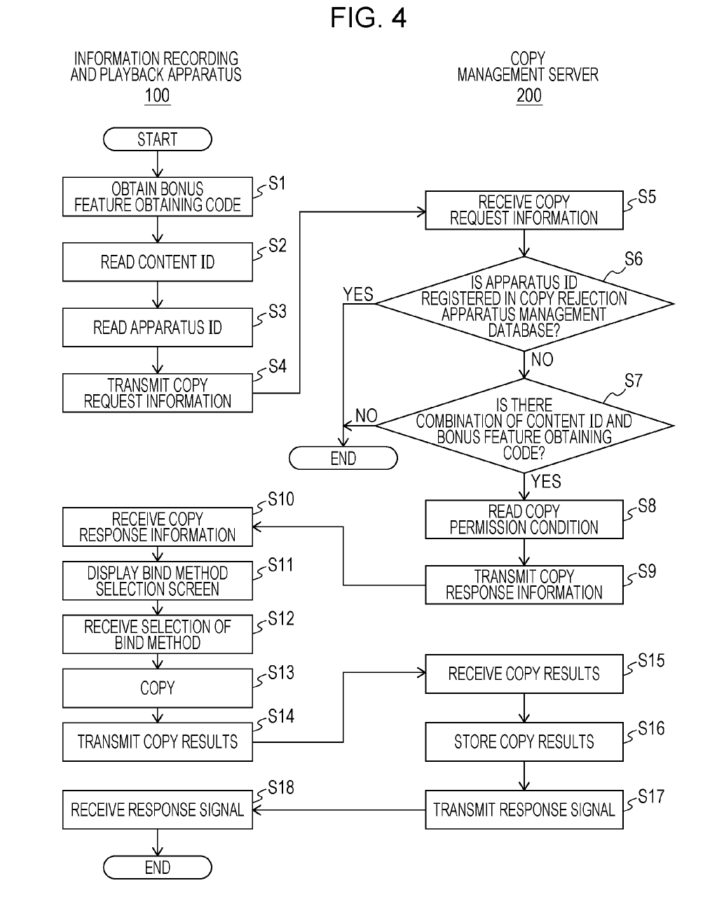

FIG. 4 is a flowchart illustrating an example of operations performed by the information recording and playback apparatus 100 and the copy management server 200 according to the first embodiment.

First, in step S1, the input processing unit 116 of the information recording and playback apparatus 100 obtains the bonus feature obtaining code 330. The input processing unit 116 receives the bonus feature obtaining code 330 input by the user and obtains the bonus feature obtaining code 330. The bonus feature obtaining code 330 is attached to an optical disc package 350 including the optical disc 310.

In step S2, the playback control unit 118 reads the content ID from the optical disc 310. The content ID is stored in a certain region of the optical disc 310.

In step S3, the system control unit 110 reads the apparatus ID from the apparatus ID storage unit 112.

In step S4, the communication control unit 114 transmits copy request information including the bonus feature obtaining code 330, the content ID, and the apparatus ID to the copy management server 200.

In step S5, the copying process management unit 210 of the copy management server 200 receives the copy request information transmitted from the information recording and playback apparatus 100.

In step S6, the copying process management unit 210 determines whether the apparatus ID included in the received copy request information is registered in the copy rejection apparatus management database 230. If the copying process management unit 210 determines that the apparatus ID is registered in the copy rejection apparatus management database 230 (YES in step S6), the copying process management unit 210 determines that the copy request information has been transmitted from an inappropriate apparatus, and ends the process. At this time, the copying process management unit 210 may transmit, to the information recording and playback apparatus 100, copy rejection information indicating that the apparatus that has transmitted the copy request information is an inappropriate apparatus that is not permitted to copy content data. Upon receiving the copy rejection information, the information recording and playback apparatus 100 may display a screen indicating that copying cannot be performed.

On the other hand, if the copying process management unit 210 determines that the apparatus ID is not registered in the copy rejection apparatus management database 230 (NO in step S6), the copying process management unit 210 determines in step S7 whether a combination of the content ID and the bonus feature obtaining code 330 included in the received copy request information is registered in the bonus feature obtaining code management database 220. If the copying process management unit 210 determines that the combination of the content ID and the bonus feature obtaining code 330 is not registered in the bonus feature obtaining code management database 220 (NO in step S7), the copying process management unit 210 ends the process. In this case, the copying process management unit 210 may transmit, to the information recording and playback apparatus 100, information indicating that the bonus feature obtaining code 330 is not registered in the bonus feature obtaining code management database 220. Upon receiving the information, the information recording and playback apparatus 100 may display a screen indicating that copying cannot be performed because the bonus feature obtaining code 330 is not registered in the bonus feature obtaining code management database 220.

On the other hand, if the copying process management unit 210 determines that the combination of the content ID and the bonus feature obtaining code 330 is registered in the bonus feature obtaining code management database 220 (YES in step S7), the copying process management unit 210 reads, in step S8, a copy permission condition corresponding to the content ID from the bonus feature obtaining code management database 220. According to the copy permission condition, the user needs to select one of the three predetermined bind methods, namely the device bind method, the media bind method, and the domain bind method.

In step S9, the copying process management unit 210 transmits copy response information including the read copy permission condition to the information recording and playback apparatus 100.

In step S10, the communication control unit 114 of the information recording and playback apparatus 100 receives the copy response information transmitted from the copy management server 200.

In step 511, the system control unit 110 displays, on the television set 500, a bind method selection screen for selecting a bind method.

In step S12, the input processing unit 116 receives a bind method selected by the user. The user selects a copy destination displayed on the bind method selection screen.

After the user selects a bind method, the recording control unit 120 reads, in step S13, the content data from the optical disc 310 and copies the read content data to the copy destination selected by the user. As a result of the selection, the content data is stored in a device, a medium, or a domain in a network.

In step S14, the communication control unit 114 transmits results of the copying to the copy management server 200. The results of the copying include information indicating the bind method and the copy destination.

In step S15, the copying process management unit 210 of the copy management server 200 receives the results of the copying transmitted from the information recording and playback apparatus 100.

In step S16, the copying process management unit 210 stores the results of the copying in the bonus feature obtaining code management database 220.

After the results of the copying are normally stored in the bonus feature obtaining code management database 220, the copying process management unit 210 transmits, in step S17, a response signal to the information recording and playback apparatus 100.

In step S18, the communication control unit 114 of the information recording and playback apparatus 100 receives the response signal transmitted from the copy management server 200 and ends the process.

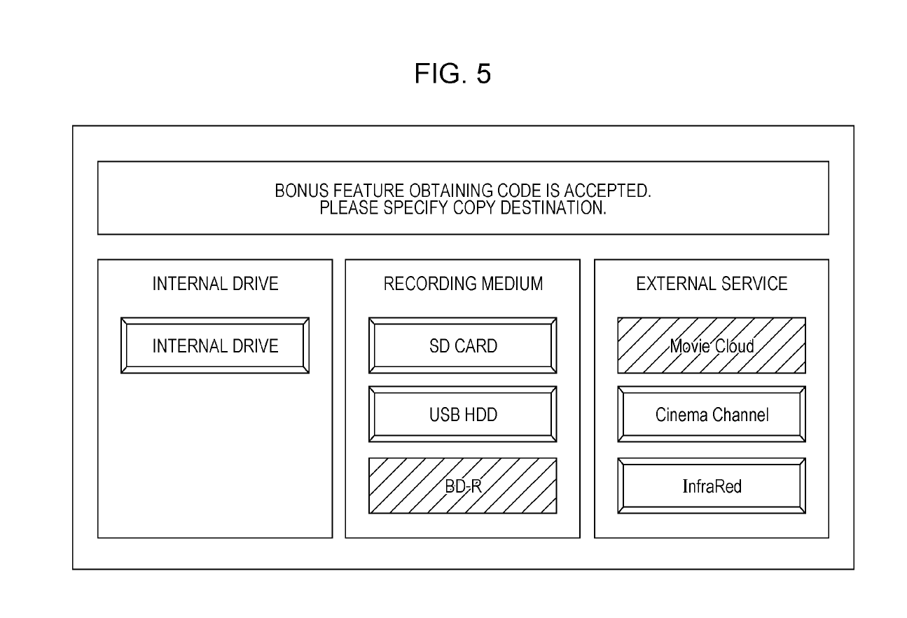

FIG. 5 is a diagram illustrating an example of the bind method selection screen displayed to the user. If the copying process management unit 210 determines in step S7 illustrated in FIG. 4 that the combination of the content ID and the bonus feature obtaining code 330 is registered in the bonus feature obtaining code management database 220 and transmits, to the information recording and playback apparatus 100, the copy response information indicating that copying is permitted, copying can be performed. The user determines the copy destination to which the content data is copied. The bind method may be, roughly speaking, the device bind method, the media bind method, or the domain bind method.

In the device bind method, data obtained as a result of copying is bound to a certain device (generally a device that has copied original data) and cannot be played back by devices other than the certain device. In FIG. 5, this option is indicated as “internal drive”. If the user selects the internal drive, the content data stored in the optical disc 310 is copied to the HDD (the device bind recording device 134) included in the information recording and playback apparatus 100. The information recording and playback apparatus 100 can play back the content data obtained as a result of the copying, but other devices cannot.

In the media bind method, data obtained as a result of copying is bound to a certain physical medium. In FIG. 5, this option is indicated as “recording medium”. The certain physical medium may be a flash memory typified by an SD card, an HDD connected to a USB part, an optical disc for recording (indicated as “BD-R” in FIG. 5), or the like. If the user selects one of the recording media, the content data stored in the optical disc 310 is copied to the selected physical medium. Any device intended for the selected physical medium can play back the content data obtained as a result of the copying.

Finally, in the domain bind method, data obtained as a result of copying is bound to a certain account of a service. In the example illustrated in FIG. 5, services named “Movie Cloud”, “Cinema Channel”, and “InfraRed” are displayed as external services. If the user has an account of each service, the content data is associated with the user's account and copied. External services are generally VOD services. A device with which the user has logged in a service or a device registered to a service in advance can stream the content data on the service. In some services, the content data can be cached in a device for a certain period of time. In this case, the content data can be played back even if the device is not connected to the network.

In FIG. 5, two options (in this example, “BD-R” as a recording medium and “Movie Cloud” as an external service) are grayed out. This is because a certain recording medium or external service might not be permitted to copy content data depending on the content provider or the type of content data. It is generally said that compared to the device bind method, in which only a certain terminal can play back content data, content data is more likely to leak out in the media bind method or the domain bind method, in which a plurality of devices can play back the content data. With respect to the media bind method, different types of media adopt different copyright protection methods, and content providers are different from one another in types of media that can be permitted to perform copying. Similarly, with respect to the domain bind method, external service providers have different security policies and copyright protection methods, and content providers might not want to permit some external service providers to copy their content data.

Such restrictions on copy destinations are included in the copy permission condition read in step S8 illustrated in FIG. 4. The bind method selection screen illustrated in FIG. 5 changes in accordance with the copy permission condition. That is, different copy destinations can be displayed for each type of content.

Information regarding a selected bind method, and a device as the copy destination, a recording medium as the copy destination, or an external service as the copy destination is transmitted in step S14 illustrated in FIG. 4 as the results of the copying. Although the copy management server 200 notifies the information recording and playback apparatus 100 that the process has been normally completed or transmits a response signal to the information recording and playback apparatus 100 after the results of the copying are stored in the bonus feature obtaining code management database 220 (step S16), the copy management server 200 may notify the information recording and playback apparatus 100 that an abnormality has occurred, if a bind method or a copy destination that is not permissible has been transmitted as the results of the copying.

Alternatively, the information regarding a bind method and a copy destination may be included in the information, which has been described with reference to FIG. 1, transmitted to the content provider management server 400 from the copy management server 200. By learning genres and copy destinations of copied content data, the content provider can conduct various marketing campaigns.

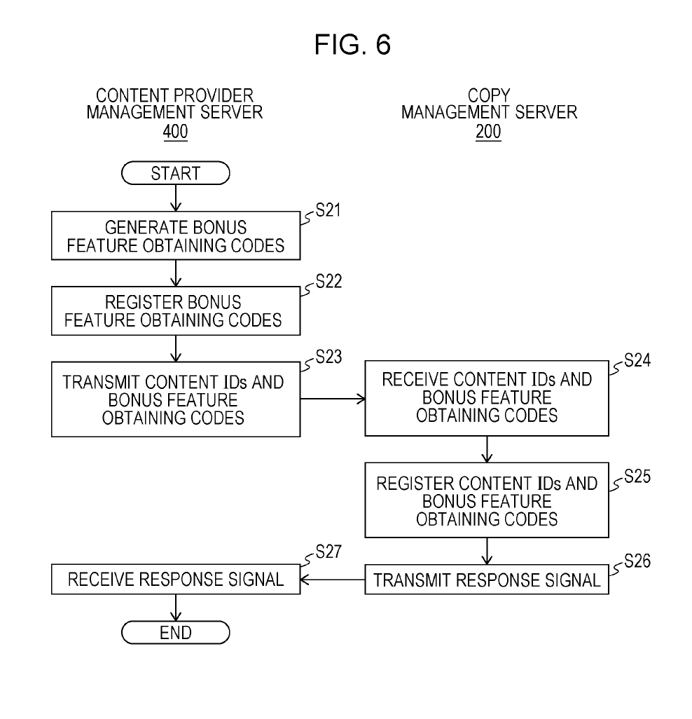

FIG. 6 is a flowchart illustrating an example of operations performed by the copy management server 200 and the content provider management server 400 according to the first embodiment.

First, in step S21, the bonus feature obtaining code registration unit 410 of the content provider management server 400 generates bonus feature obtaining codes corresponding to certain content IDs. The bonus feature obtaining code registration unit 410 preferably generates the same number of bonus feature obtaining codes as the number of optical discs manufactured in which a certain piece of content data is stored.

In step S22, the bonus feature obtaining code registration unit 410 registers the generated bonus feature obtaining codes to the bonus feature obtaining code management database 420. The generated bonus feature obtaining codes are printed on paper media, for example, and included in optical disc packages, and the optical disc packages are shipped. The price of each optical disc package including one of the bonus feature obtaining codes is preferably higher than the price of each optical disc package that does not include a bonus feature obtaining code. In doing so, the value of a copy function realized by the bonus feature obtaining code can be included in the price of each optical disc package.

In step S23, the bonus feature obtaining code registration unit 410 transmits the content IDs and the bonus feature obtaining codes to the copy management server 200.

In step S24, the copying process management unit 210 of the copy management server 200 receives the content IDs and the bonus feature obtaining codes transmitted from the content provider management server 400.

In step S25, the copying process management unit 210 registers the received content IDs and bonus feature obtaining codes to the bonus feature obtaining code management database 220. The information recording and playback apparatus 100 can thus perform the copying process in which a bonus feature obtaining code is used.

After the registration of the content IDs and the bonus feature obtaining codes is completed, the copying process management unit 210 transmits, in step S26, a response signal to the content provider management server 400.

In step S27, the bonus feature obtaining code registration unit 410 of the content provider management server 400 receives the response signal transmitted from the copy management server 200 and ends the process.

Although not illustrated in FIG. 6, the bonus feature obtaining code registration unit 410 may transmit information regarding a bind method or a copy destination to the copy management server 200 as a copy permission condition. In doing so, the selection of a bind method or a copy destination illustrated in FIG. 5 can be possible.

In the process illustrated in FIG. 6, the value of a right of copying becomes clear, and it is easy to reserve rights of owners of copyright. Since the content provider management server 400 does not perform a charging process, promotion of content and a price revision can be easily conducted. The content provider needs to manage the bonus feature obtaining codes, but a disc manufacturer may manage the bonus feature obtaining codes instead of the content provider. Furthermore, the user need not perform a purchase and transaction process. Consumer appliances may only have a function of inputting a bonus feature obtaining code. Since the copy management server 200 need not perform a charging process or issue bonus feature obtaining codes, the process can be simplified, and the copy management server 200 can be easily operated.

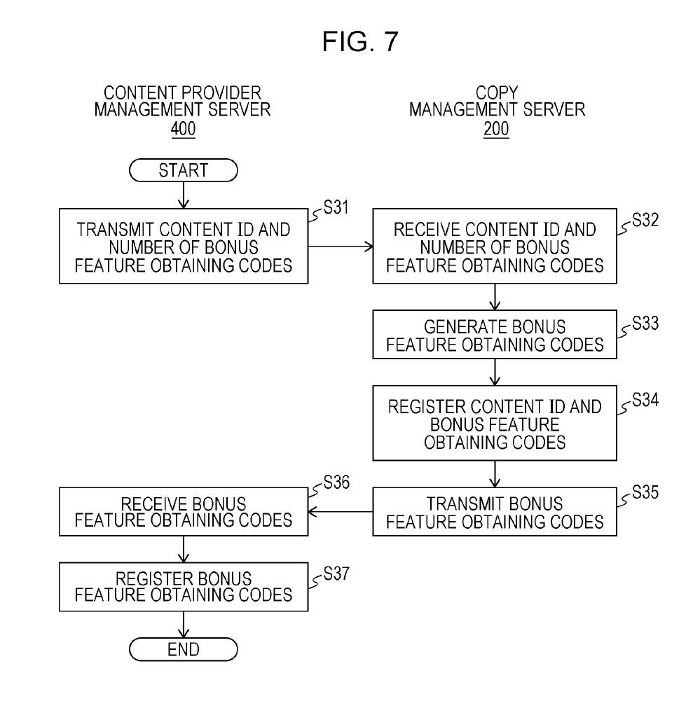

FIG. 7 is a flowchart illustrating an example of operations performed by the copy management server 200 and the content provider management server 400 according to a modification of the first embodiment. In this modification, unlike in FIG. 6, the content provider management server 400 does not generate unique bonus feature obtaining codes, but the copy management server 200 generates common bonus feature obtaining codes.

First, in step S31, the bonus feature obtaining code registration unit 410 of the content provider management server 400 transmits a content ID and the number of bonus feature obtaining codes to the copy management server 200. Because the same number of bonus feature obtaining codes as the number of optical discs manufactured are needed, the content provider management server 400 transmits the necessary number of bonus feature obtaining codes to the copy management server 200.

In step S32, the copying process management unit 210 of the copy management server 200 receives the content ID and the number of bonus feature obtaining codes transmitted from the content provider management server 400.

In step S33, the copying process management unit 210 generates the bonus feature obtaining codes in accordance with a request from the content provider management server 400.

In step S34, the copying process management unit 210 registers the received content ID and the generated bonus feature obtaining codes to the bonus feature obtaining code management database 220 along with a copy permission condition.

In step S35, the copying process management unit 210 transmits the generated bonus feature obtaining codes to the content provider management server 400.

In step S36, the bonus feature obtaining code registration unit 410 of the content provider management server 400 receives the bonus feature obtaining codes transmitted from the copy management server 200. The received bonus feature obtaining codes are printed on paper media, for example, and included in optical disc packages, and the optical disc packages are shipped. The price of each optical disc package including one of the bonus feature obtaining codes is preferably higher than the price of each optical disc package that does not include a bonus feature obtaining code.

In step S37, the bonus feature obtaining code registration unit 410 registers the received bonus feature obtaining codes to the bonus feature obtaining code management database 420. In doing so, the information recording and playback apparatus 100 can perform the copying process in which a bonus feature obtaining code is used.

In the process illustrated in FIG. 7, the value of a right of copying becomes clear, and it is easy to reserve rights of owners of copyright. Since the content provider management server 400 does not perform a charging process, promotion of content and a price revision can be easily conducted. Since the content provider need not manage the bonus feature obtaining codes, even a small content provider can adopt this scheme. Furthermore, the user need not perform a purchase and transaction process. Consumer appliances may only have a function of inputting a bonus feature obtaining code. The copy management server 200 needs to issue bonus feature obtaining codes, but since a charging process is not necessary, the process can be simplified, and the copy management server 200 can be easily operated.

### Second Embodiment

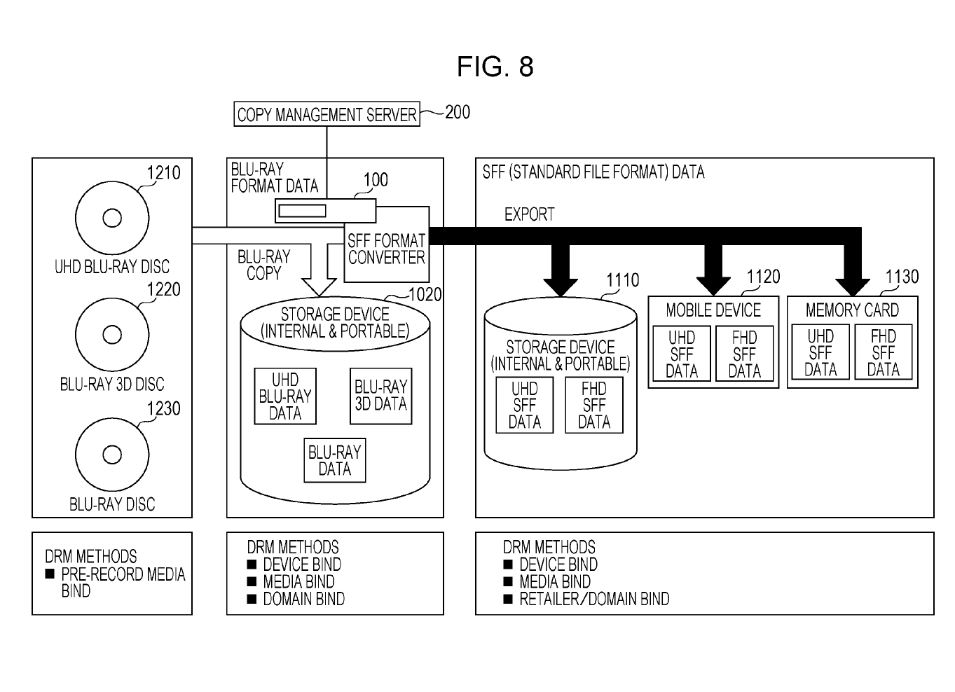

FIG. 8 is a diagram illustrating an example of an operational overview of a process for copying content performed in a copy control system according to a second embodiment. In the process for copying content, content data is copied in a Blu-ray data format based on transport stream (TS), but content data may be converted into an SFF, which is one of MP4 formats, and copied, instead. The MP4 formats are file formats specified as a part of MPEG-4, which is a standard for compression and coding of moving images. The SFF is a technique equivalent to a common file format (CFF) disclosed by the Digital Entertainment Content Ecosystem (DECE). If the file format is converted, content data is output after the file format of the content data is converted into an MP4 format to enable a device such as a PC, a smartphone, or a tablet computer to play back the content data. Although the Blu-ray data format encompasses all types of Blu-ray discs, the MP4 formats are not intended for Blu-ray 3D discs.

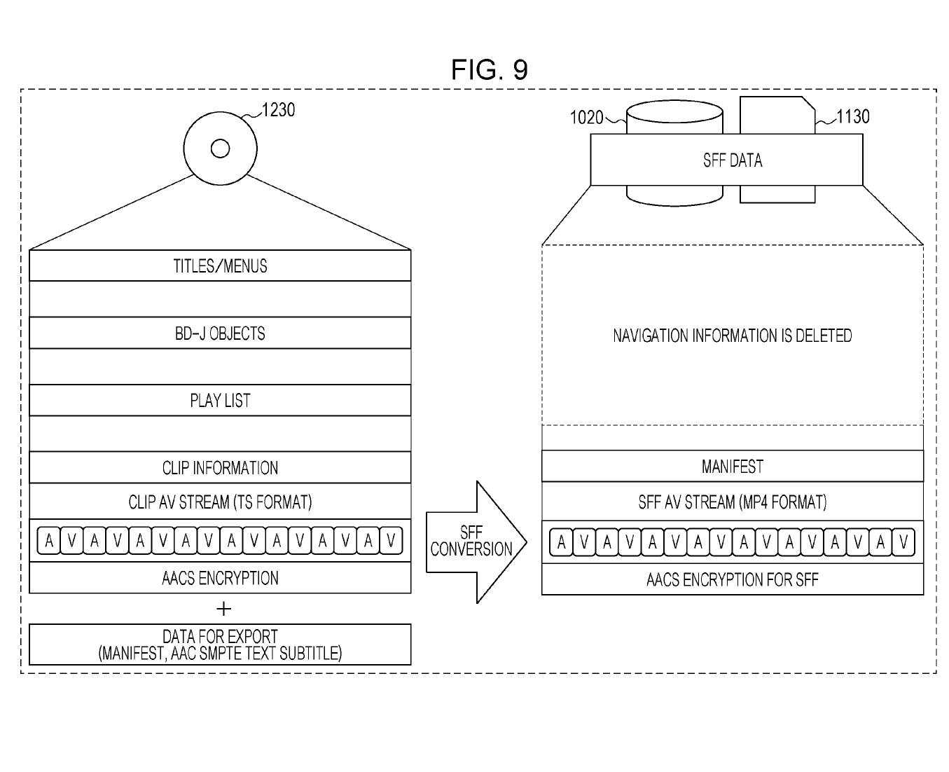

FIG. 9 is a diagram illustrating the structure of SFF data generated as a result of an SFF export process. In the SFF, not only data stored in a Blu-ray 3D disc cannot be converted, but also navigation information essential for interactive functions such as a game function and an Internet coordination function is deleted in a menu or Java (registered trademark). The structure of SFF data is therefore simple, including only AV streams, subtitle information, and management information. Data necessary for exporting is obtained from a Blu-ray disc or through a network.

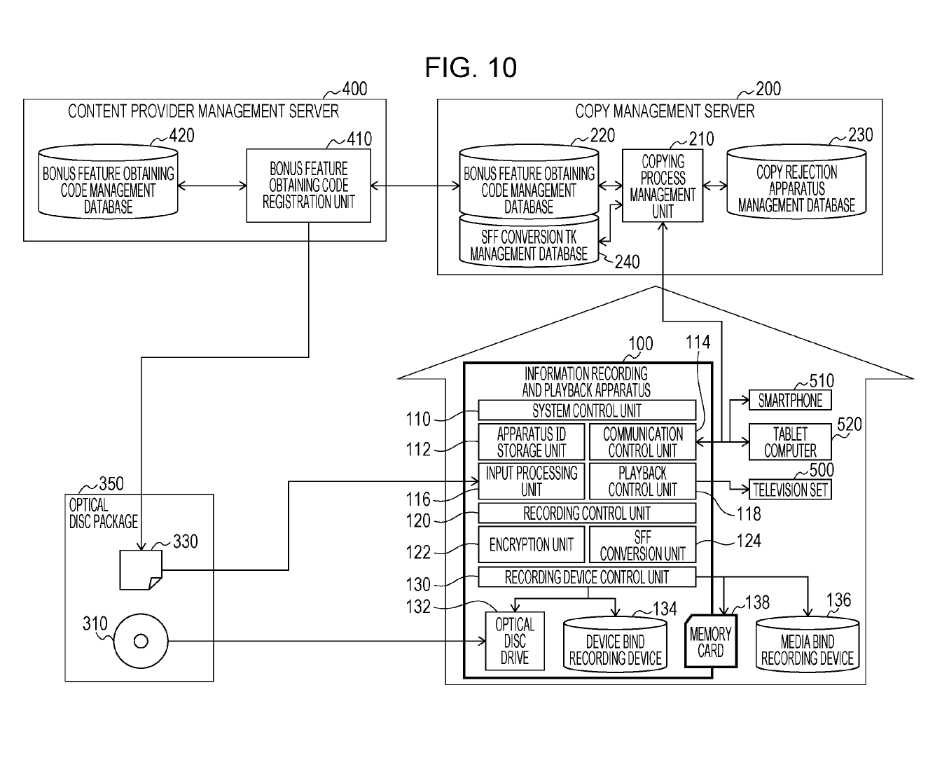

FIG. 10 is a diagram illustrating an overall configuration of the copy control system according to the second embodiment of the present disclosure. The copy control system illustrated in FIG. 10 is obtained by adding an SFF conversion function to the configuration of the copy control system illustrated in FIG. 1.

An information recording and playback apparatus 100 includes the system control unit 110, the apparatus ID storage unit 112, the communication control unit 114, the input processing unit 116, the playback control unit 118, the recording control unit 120, the encryption unit 122, an SFF conversion unit 124, the recording device control unit 130, the optical disc drive 132, and the device bind recording device 134. A copy management server 200 includes the copying process management unit 210, the bonus feature obtaining code management database 220, the copy rejection apparatus management database 230, and an SFF conversion title key (TK) management database 240. In the copy control system according to the second embodiment, description of the same components as those of the copy control system illustrated in FIG. 1 is omitted.

The recording control unit 120 generates an SFF file by controlling the SFF conversion unit 124 and transmits the SFF file to the recording device control unit 130. The SFF is thus supported. The SFF conversion unit 124 converts a file format of the content data stored in the optical disc 310 into another file format. In order to convert a TS format into an MP4 format through SFF conversion, the SFF conversion unit 124 decrypts encrypted Blu-ray data and then encrypts the Blu-ray data again in a common encryption format. At this time, the information recording and playback apparatus 100 needs to obtain a TK for encryption from the copy management server 200. For this purpose, the copy management server 200 includes the SFF conversion TK management database 240 used for storing SFF conversion TKs. The copy management server 200 transmits the SFF conversion TK to the information recording and playback apparatus 100 after copying is permitted. Operations performed by components other than the SFF conversion unit 124 and the SFF conversion TK management database 240 are basically the same as those performed by the components illustrated in FIG. 1.

The copy permission condition includes a condition that a file format of content data obtained as a result of copying be selected from a plurality of predetermined file formats. Copying is permitted by selecting one of the plurality of file formats. The plurality of file formats include, for example, the TS format and the MP4 format. The recording control unit 120 receives one of the plurality of file formats selected by the user and copies the content data in the received file format.

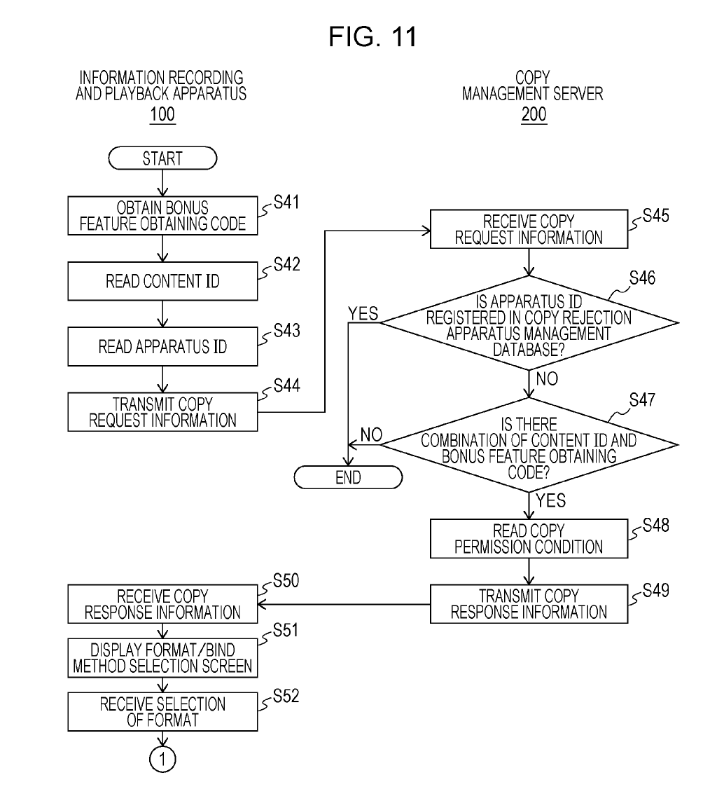

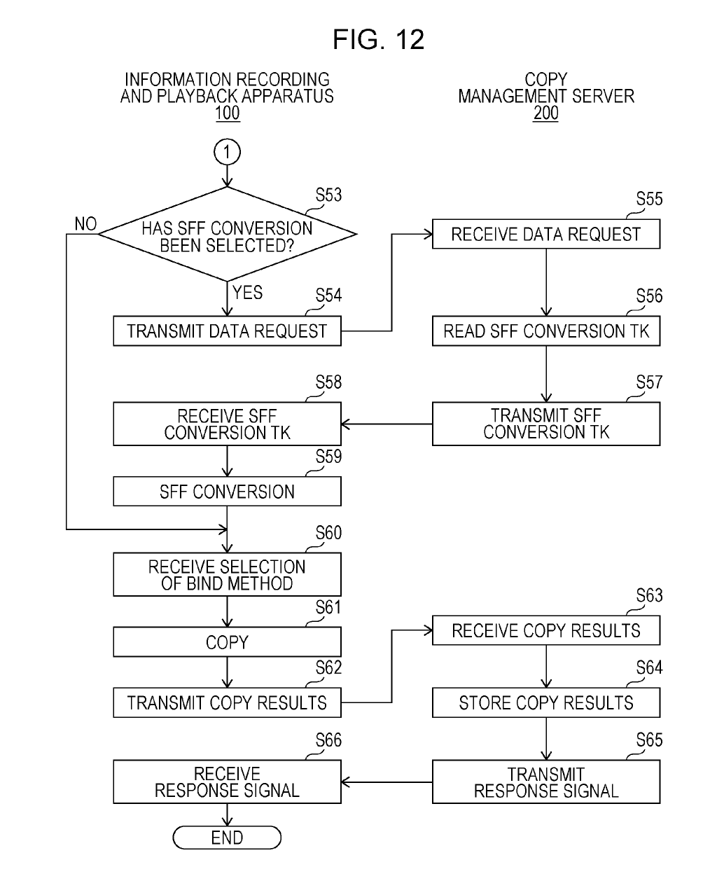

FIG. 11 is a first flowchart illustrating an example of operations performed by the information recording and playback apparatus 100 and the copy management server 200 according to the second embodiment. FIG. 12 is a second flowchart illustrating the operations performed by the information recording and playback apparatus 100 and the copy management server 200 according to the second embodiment. Basic operations indicated in the flowcharts of FIGS. 11 and 12 are the same as those indicated in the flowchart of FIG. 4. A process performed for the SFF conversion is added to the flowcharts of FIGS. 11 and 12. In the example illustrated in FIGS. 11 and 12, the copy management server 200 manages the SFF conversion TKs and transmits one of the SFF conversion TKs to the information recording and playback apparatus 100.

Processing in steps S41 to S47 is the same as that in steps S1 to S7 illustrated in FIG. 4, and description thereof is omitted.

If the copying process management unit 210 determines that the combination of the content ID and the bonus feature obtaining code is registered in the bonus feature obtaining code management database 220 (YES in step S47), the copying process management unit 210 reads, in step S48, a copy permission condition corresponding to the content ID from the bonus feature obtaining code management database 220. According to the copy permission condition, the user needs to select one of the three predetermined bind methods, namely the device bind method, the media bind method, and the domain bind method, and the file format of content data obtained as a result of copying.

Processing in steps S49 and S50 is the same as that in steps S9 and S10 illustrated in FIG. 4, and description thereof is omitted.

In step S51, the system control unit 110 displays, on the television set 500, a format/bind method selection screen for selecting a file format and a bind method.

In step S52, the input processing unit 116 receives a file format selected by the user. The user selects one of file formats displayed in the format/bind method selection screen.

In step S53, the recording control unit 120 determines whether the SFF conversion has been selected. If the recording control unit 120 determines that the SFF conversion has not been selected (NO in step S53), the process proceeds to step S60.

On the other hand, if the recording control unit 120 determines that the SFF conversion has been selected (YES in step S53), the communication control unit 114 transmits, in step S54, a data request to the copy management server 200 to request an SFF conversion TK.

In step S55, the copying process management unit 210 of the copy management server 200 receives the data request transmitted from the information recording and playback apparatus 100.

In step S56, the copying process management unit 210 reads an SFF conversion TK from the SFF conversion TK management database 240.

In step S57, the copying process management unit 210 transmits the read SFF conversion TK to the information recording and playback apparatus 100.

In step S58, the communication control unit 114 of the information recording and playback apparatus 100 receives the SFF conversion TK transmitted from the copy management server 200.

In step S59, the SFF conversion unit 124 decrypts the content data read from the optical disc 310 and encrypts the decrypted content data again using the SFF conversion TK. The SFF conversion unit 124 then converts the file format of the encrypted content data into the SFF.

In step S60, the input processing unit 116 receives a bind method selected by the user. The user selects one of copy destinations displayed in the format/bind method selection screen.

After a bind method is selected, the recording control unit 120 copies, in step S61, the content data whose file format has been converted into the SFF to the copy destination selected by the user. As a result of the selection, the content data is stored in a device, a medium, or a domain in a network.

Processing in steps S62 to S66 is the same as that in steps S14 to S18 illustrated in FIG. 4, and description thereof is omitted.

Next, operations performed by the information recording and playback apparatus 100 and the copy management server 200 according to a modification of the second embodiment will be described.

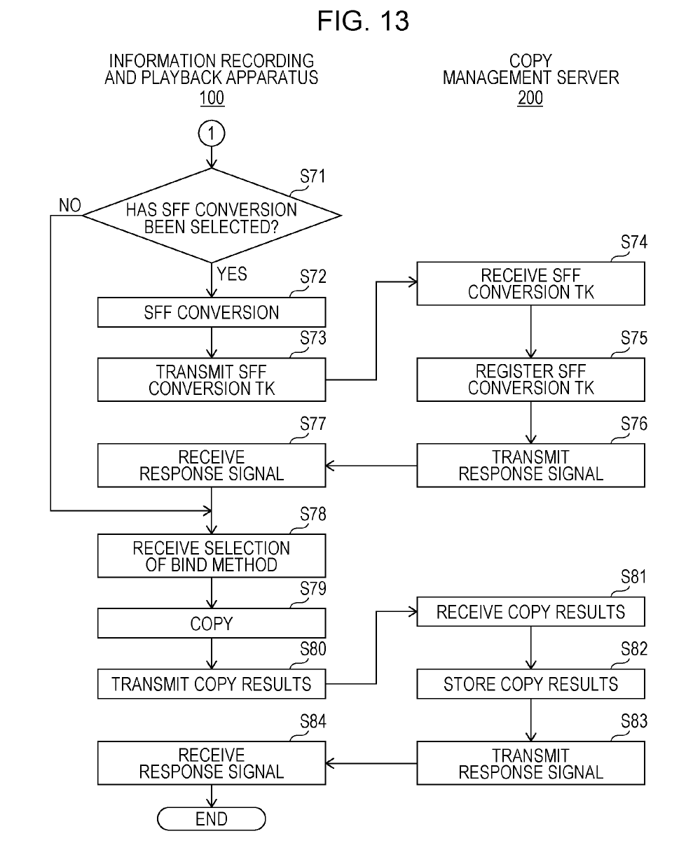

FIG. 13 is a flowchart illustrating an example of the operations performed by the information recording and playback apparatus 100 and the copy management server 200 according to the modification of the second embodiment. The flowchart of FIG. 13 is different from the flowcharts of FIGS. 11 and 12 in terms of the method for generating an SFF conversion TK. In the example illustrated in FIG. 13, the information recording and playback apparatus 100 automatically generates an SFF conversion TK. The information recording and playback apparatus 100 then transmits the SFF conversion TK to the copy management server 200, which manages the SFF conversion TK. The SFF conversion TK is registered to the SFF conversion TK management database 240.

First, the processing in steps S41 to S52 illustrated in FIG. 11 is performed.

In step S71, the recording control unit 120 determines whether the SFF conversion has been selected. If the recording control unit 120 determines that the SFF conversion has not been selected (NO in step S71), the process proceeds to step S78.

On the other hand, if the recording control unit 120 determines that the SFF conversion has been selected (YES in step S71), the SFF conversion unit 124 generates, in step S72, an SFF conversion TK, decrypts the content data read from the optical disc 310, encrypts the decrypted content data again using the generated SFF conversion TK, and converts the file format of the encrypted content data into the SFF.

In step S73, the communication control unit 114 transmits the SFF conversion TK generated by the SFF conversion unit 124 to the copy management server 200.

In step S74, the copying process management unit 210 of the copy management server 200 receives the SFF conversion TK transmitted from the information recording and playback apparatus 100.

In step S75, the copying process management unit 210 registers the received SFF conversion TK to the SFF conversion TK management database 240. At this time, the copying process management unit 210 associates the SFF conversion TK with a combination of a content ID and a bonus feature obtaining code and stores the SFF conversion TK in the SFF conversion TK management database 240.

After the SFF conversion TK is normally registered, the copying process management unit 210 transmits, in step S76, a response signal to the information recording and playback apparatus 100.

In step S77, the communication control unit 114 of the information recording and playback apparatus 100 receives the response signal transmitted from the copy management server 200.

Processing in steps S78 to S84 is the same as that in steps S60 to S66 illustrated in FIG. 12, and description thereof is omitted.

### Third Embodiment

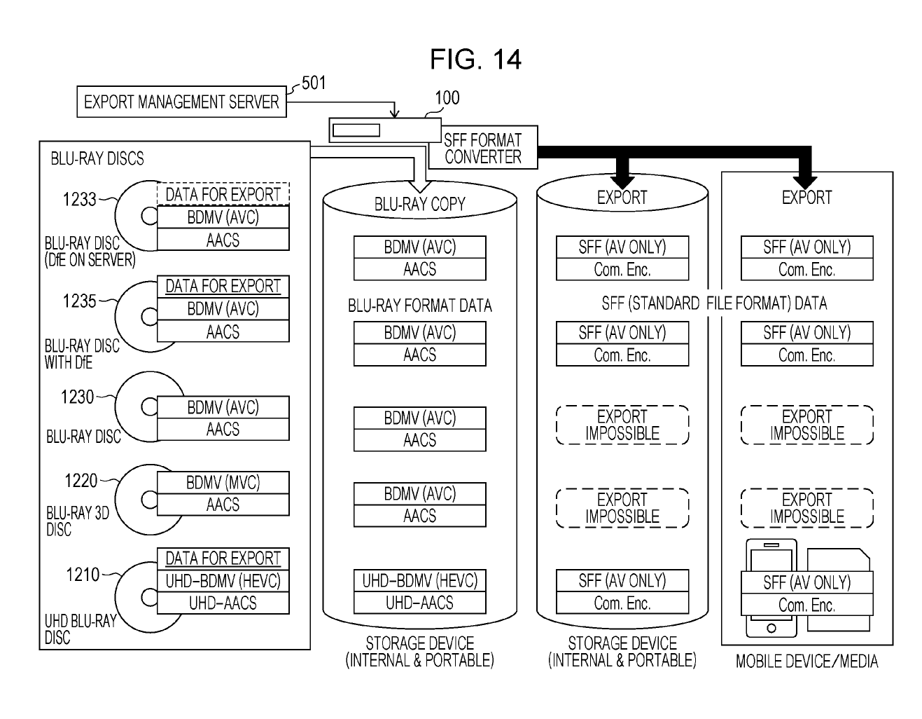

FIG. 14 is a diagram illustrating a relationship between an SFF export function and data for export according to a third embodiment. Because the SFF conversion requires complex processing, data for export is defined as data for efficiently performing the conversion. If there is no data for export, Blu-ray data can be copied, but the conversion into the SFF is prohibited. The data for export is stored in optical discs in advance, but for optical discs that have already be sold and in which the data for export is not stored, the data for export is stored in an export management server 501.

That is, as illustrated in FIG. 14, if the data for export is not stored in a Blu-ray disc, the information recording and playback apparatus 100 obtains the data for export from the export management server 501.

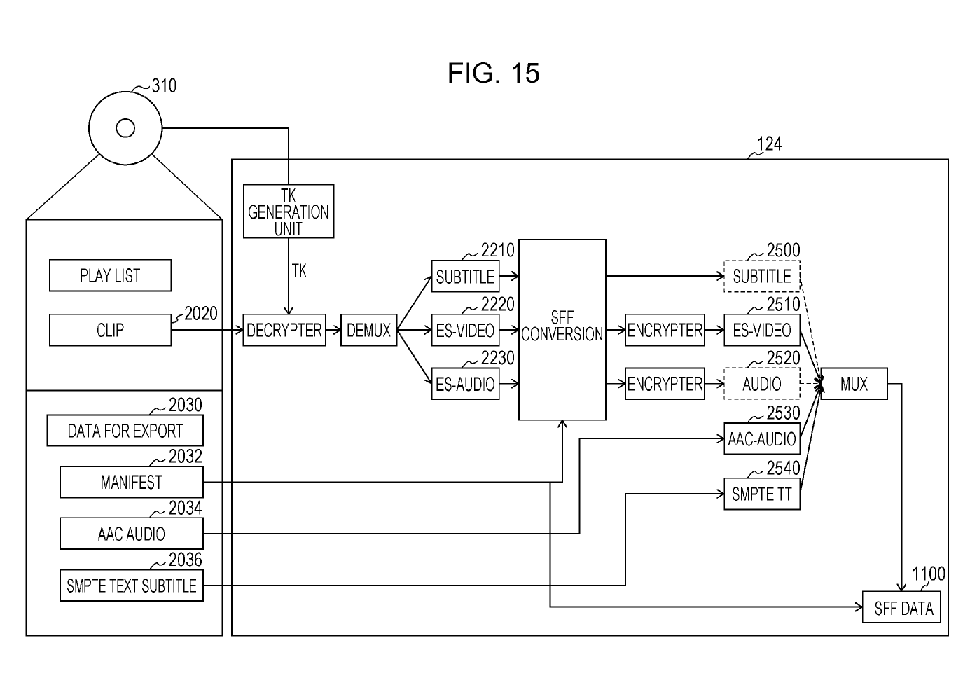

FIG. 15 is a diagram illustrating the configuration of the SFF conversion unit 124, which performs the SFF export process. As illustrated in FIG. 15, after being decrypted, clip data 2020 is divided into subtitles 2210, ES-video 2220, and ES-audio 2230 and subjected to the SFF conversion. Data for export 2030 includes a manifest 2032, Advanced Audio Coding (AAC) audio 2034, and Society of Motion Picture and Television Engineers (SMPTE) text subtitles 2036. The manifest 2032 is used for the SFF conversion. Among the subtitles 2500, the ES-video 2510, and the ES-audio 2520 subjected to the SFF conversion, the ES-video 2510 is multiplexed with AAC audio 2530 and the SMPTE Timed Text (TT) 2540 included in the data for export 2030 and output as SFF data 1100. Audio data and subtitles data are thus replaced by the AAC audio 2530 and the SMPTE TT 2540 included in the data for export 2030.

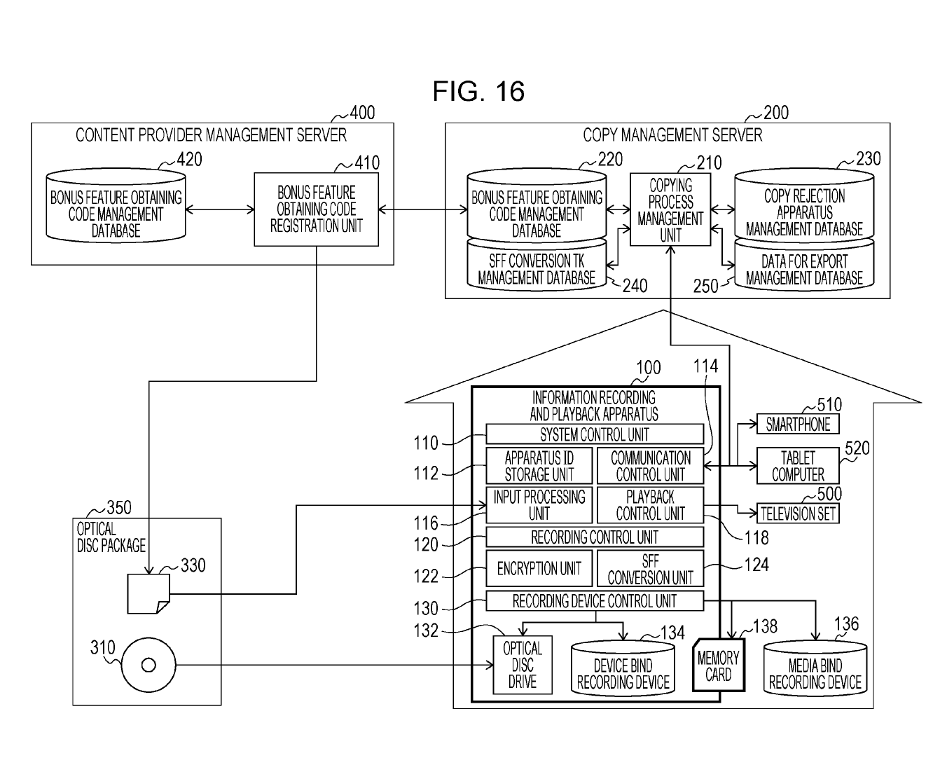

FIG. 16 is a diagram illustrating an overall configuration of a copy control system according to the third embodiment of the present disclosure. An only difference from the configuration illustrated in FIG. 10 is that a copy management server 200 according to the third embodiment includes a data for export management database 250 used for storing and managing the data for export.

The copy management server 200 includes the copying process management unit 210, the bonus feature obtaining code management database 220, the copy rejection apparatus management database 230, the SFF conversion TK management database 240, and the data for export management database 250. In the copy control system according to the third embodiment, description of the same components as those of the copy control system illustrated in FIG. 10 is omitted.

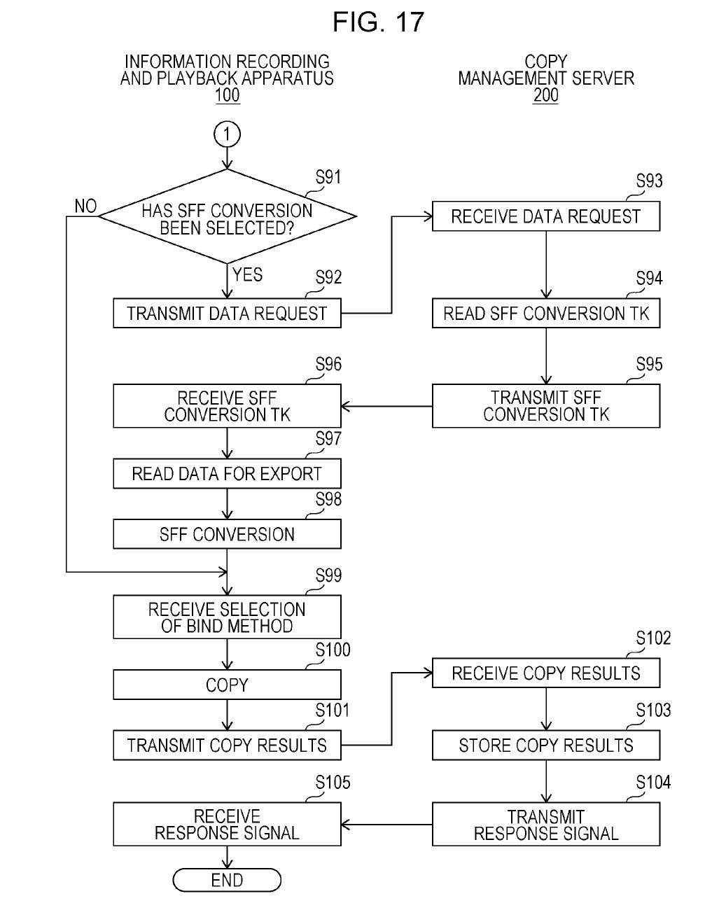

FIG. 17 is a flowchart illustrating an example of operations performed by the information recording and playback apparatus 100 and the copy management server 200 according to the third embodiment. The flowchart of FIG. 17 is obtained by adding processing relating to the data for export to the process illustrated in FIGS. 11 and 12. The process illustrated in FIG. 17 is an example in which the data for export is stored in the optical disc 310.

First, the processing in steps S41 to S52 illustrated in FIG. 11 is performed. Processing in steps S91 to S96 is the same as that in steps S53 to S58 illustrated in FIG. 12, and description thereof is omitted.

In step S97, the SFF conversion unit 124 reads the data for export stored in the optical disc 310.

In step S98, the SFF conversion unit 124 decrypts the content data read from the optical disc 310, encrypts the decrypted content data again using the received SFF conversion TK, and converts the file format of the encrypted content data into the SFF using the read data for export.

Processing in steps S99 to S105 is the same as that in steps S60 to S66 illustrated in FIG. 12, and description thereof is omitted.

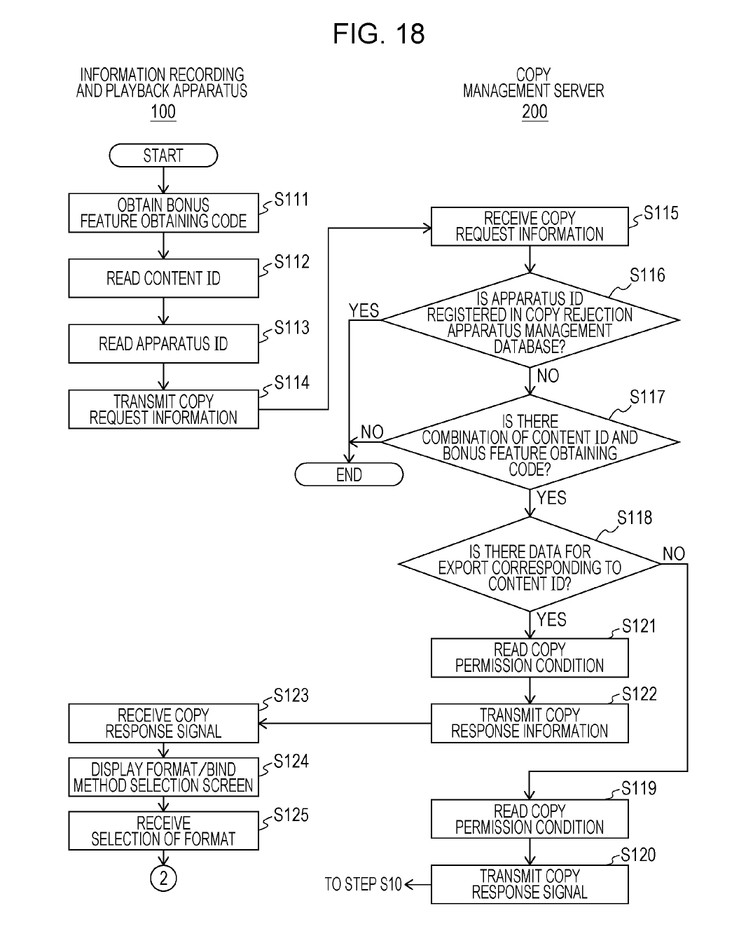

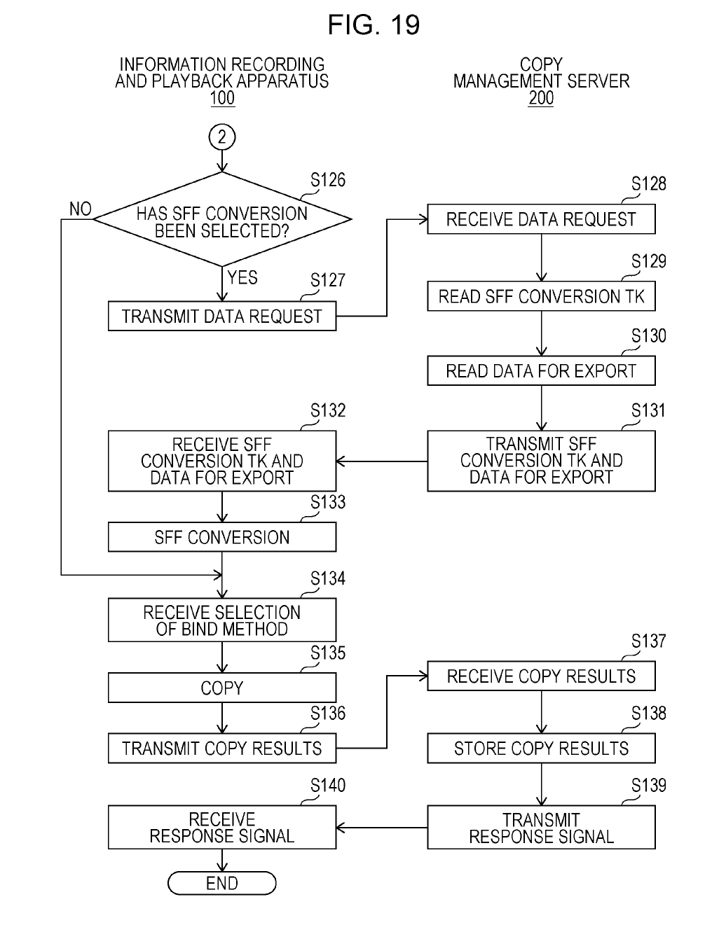

FIG. 18 is a first flowchart illustrating an example of operations performed by the information recording and playback apparatus 100 and the copy management server 200 according to a modification of the third embodiment. FIG. 19 is a second flowchart illustrating the example of the operations performed by the information recording and playback apparatus 100 and the copy management server 200 according to the modification of the third embodiment. A process illustrated in FIGS. 18 and 19 is an example in which the data for export is not stored in the optical disc 310 and is obtained from the copy management server 200.

Processing in steps S111 to S117 is the same as that in steps S1 to S7 illustrated in FIG. 4, and description thereof is omitted.

If the copying process management unit 210 determines that the combination of the content ID and the bonus feature obtaining code is registered in the bonus feature obtaining code management database 220 (YES in step S117), the copying process management unit 210 determines in step S118 whether data for export corresponding to the received content ID is registered in the data for export management database 250.

If the copying process management unit 210 determines that the data for export corresponding to the content ID is not registered in the data for export management database 250 (NO in step S118), the copying process management unit 210 reads, in step S119, a copy permission condition corresponding to the content ID from the bonus feature obtaining code management database 220. According to the copy permission condition, the user needs to select one of the three predetermined bind methods, namely the device bind method, the media bind method, and the domain bind method. The copy permission condition does not include selection of the file format of content data obtained as a result of copying. That is, since there is no data for export and the SFF conversion cannot be performed, the file format need not be selected.

In step S120, the copying process management unit 210 transmits copy response information including the read copy permission condition to the information recording and playback apparatus 100.

After the processing in step S120, the process proceeds to step S10 illustrated in FIG. 4. The processing in steps S10 to S18 illustrated in FIG. 4 is performed.

On the other hand, if the copying process management unit 210 determines that the data for export corresponding to the content ID is registered in the data for export management database 250 (YES in step S118), the copying process management unit 210 reads, in step S121, a copy permission condition corresponding to the content ID from the bonus feature obtaining code management database 220. According to the copy permission condition, the user needs to select one of the three bind methods, namely the device bind method, the media bind method, and the domain bind method, and the file format of content data obtained as a result of copying. Since there is data for export and the SFF conversion can be performed, the bind method and the file format need to be selected.

Processing in steps S122 to S126 is the same as that in steps S49 to S53 illustrated in FIGS. 11 and 12, and description thereof is omitted.

If the recording control unit 120 determines that the SFF conversion has been selected (YES in step S126), the communication control unit 114 transmits, in step S127, a data request to the copy management server 200 to request an SFF conversion TK and data for export.

In step S128, the copying process management unit 210 of the copy management server 200 receives the data request transmitted from the information recording and playback apparatus 100.

In step S129, the copying process management unit 210 reads an SFF conversion TK from the SFF conversion TK management database 240.

In step S130, the copying process management unit 210 reads data for export from the data for export management database 250.

In step S131, the copying process management unit 210 transmits the read SFF conversion TK and data for export to the information recording and playback apparatus 100.

In step S132, the communication control unit 114 of the information recording and playback apparatus 100 receives the SFF conversion TK and the data for export transmitted from the copy management server 200.

In step S133, the SFF conversion unit 124 decrypts the content data read from the optical disc 310, encrypts the decrypted content data again using the received SFF conversion TK, and converts the file data of the encrypted content data into the SFF.

Processing in steps S134 to S140 is the same as that in steps S60 to S66 illustrated in FIG. 12, and description thereof is omitted.

### Fourth Embodiment

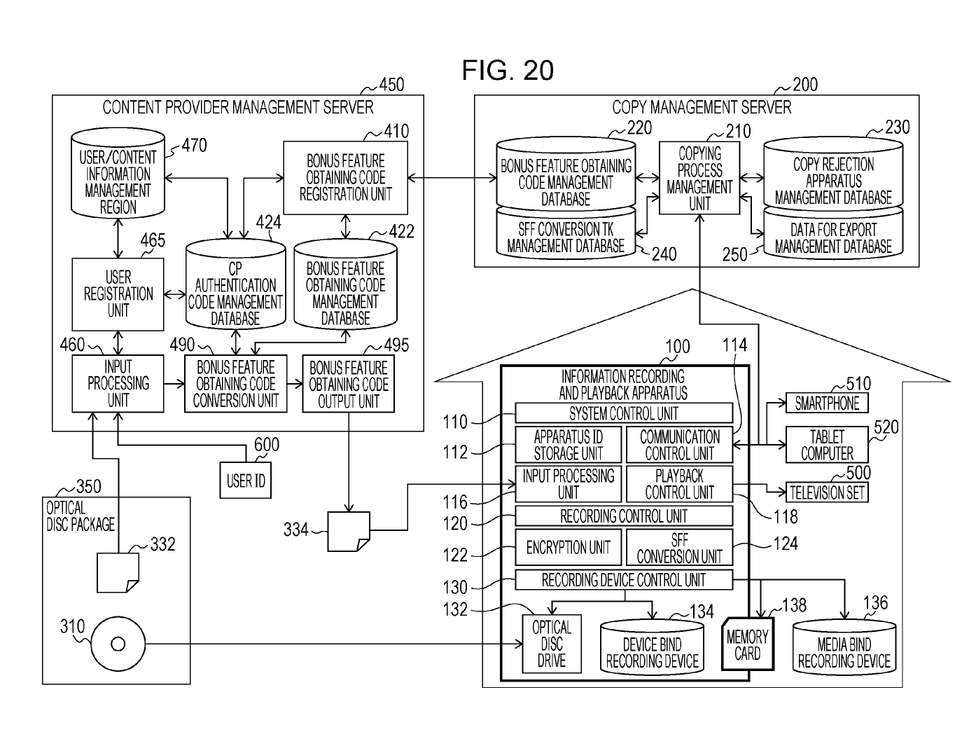

FIG. 20 is a diagram illustrating an overall configuration of a copy control system according to a fourth embodiment of the present disclosure. In the fourth embodiment, the content provider collects customer information using bonus feature obtaining codes. The configuration of a content provider management server 450 of the copy control system illustrated in FIG. 20 is different from that of the content provider management server 400 of the copy control system illustrated in FIG. 16, but the configuration of a copy management server 200 and an information recording and playback apparatus 100 of the copy control system illustrated in FIG. 20 is the same as that of the information recording and playback apparatus 100 and the copy management server 200 of the copy control system illustrated in FIG. 16.

The copy control system illustrated in FIG. 20 includes the information recording and playback apparatus 100, the copy management server 200, the content provider management server 450, the television set 500, and the smartphone 510.

The content provider management server 450 issues an authentication code (content provider (CP) authentication code 332) for the content provider. The CP authentication code 332 is included in the package of the optical disc 310. If the content data stored in the optical disc 310 is copied to another recording medium, first, the user performs user registration on the content provider management server 450 to obtain a user ID 600. The user then registers the user ID 600 and the CP authentication code 332 to the content provider management server 450 to obtain a bonus feature obtaining code 334. Processing performed after the bonus feature obtaining code 334 is input to the information recording and playback apparatus 100 is the same as that according to the third embodiment.

The content provider management server 450 includes the bonus feature obtaining code registration unit 410, a bonus feature obtaining code management database 422, a CP authentication code management database 424, an input processing unit 460, a user registration unit 465, a user/content information management region 470, a bonus feature obtaining code conversion unit 490, and a bonus feature obtaining code output unit 495.

The bonus feature obtaining code management database 422 is used for storing combinations of content IDs and bonus feature obtaining codes.

The bonus feature obtaining code registration unit 410 registers combinations of content IDs and bonus feature obtaining codes to the bonus feature obtaining code management database 422. Alternatively, the bonus feature obtaining code registration unit 410 may transmit content IDs to the copy management server 200, receive bonus feature obtaining codes associated with the content IDs, and register combinations of the content IDs and the received bonus feature obtaining codes to the bonus feature obtaining code management database 422.

The CP authentication code management database 424 is used for storing content IDs and CP authentication codes associated with each other. The input processing unit 460 receives a user ID as well as a CP authentication code. The input processing unit 460 receives the user ID and the CP authentication code through a network.

The user registration unit 465 associates the user ID received by the input processing unit 460 and a content ID obtained on the basis of the CP authentication code received by the input processing unit 460 with each other and registers the user ID and the content ID to the user/content information management region 470. The user/content information management region 470 is used for storing user IDs and content IDs associated with each other. The bonus feature obtaining code conversion unit 490 reads a bonus feature obtaining code corresponding to a content ID from the bonus feature obtaining code management database 422. The bonus feature obtaining code output unit 495 outputs the bonus feature obtaining code read by the bonus feature obtaining code conversion unit 490.

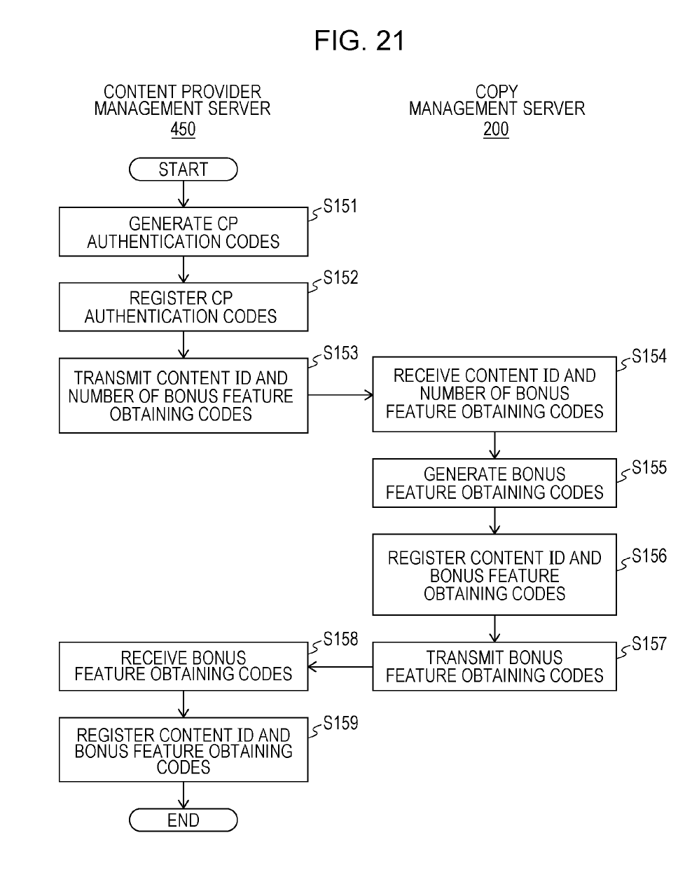

FIG. 21 is a flowchart illustrating an example of operations performed by the copy management server 200 and the content provider management server 450.

First, in step S151, the bonus feature obtaining code registration unit 410 of the content provider management server 450 generates CP authentication codes corresponding to a certain content ID.

In step S152, the bonus feature obtaining code registration unit 410 associates the generated CP authentication codes with the content ID and registers the CP authentication codes and the content ID to the CP authentication code management database 424. The generated CP authentication codes are printed on paper media, for example, and included in optical disc packages, and the optical disc packages are shipped.

In step S513, the bonus feature obtaining code registration unit 410 transmits the content ID and the number of bonus feature obtaining codes to the copy management server 200.

In step S154, the copying process management unit 210 of the copy management server 200 receives the content ID and the number of bonus feature obtaining codes transmitted from the content provider management server 450.

In step S155, the copying process management unit 210 generates the bonus feature obtaining codes in accordance with a request from the content provider management server 450.

In step S156, the copying process management unit 210 registers the received content ID and the generated bonus feature obtaining codes to the bonus feature obtaining code management database 220 along with copy permission conditions.

In step S157, the copying process management unit 210 transmits the generated bonus feature obtaining codes to the content provider management server 450.

In step S158, the bonus feature obtaining code registration unit 410 of the content provider management server 450 receives the bonus feature obtaining codes transmitted from the copy management server 200.

In step S159, the bonus feature obtaining code registration unit 410 associates the received bonus feature obtaining codes with the content ID and registers the bonus feature obtaining codes and the content ID to the bonus feature obtaining code management database 422.

As a result of the above process, the CP authentication codes and the content ID are associated with each other and registered, and the bonus feature obtaining codes and the content ID are associated with each other and registered.

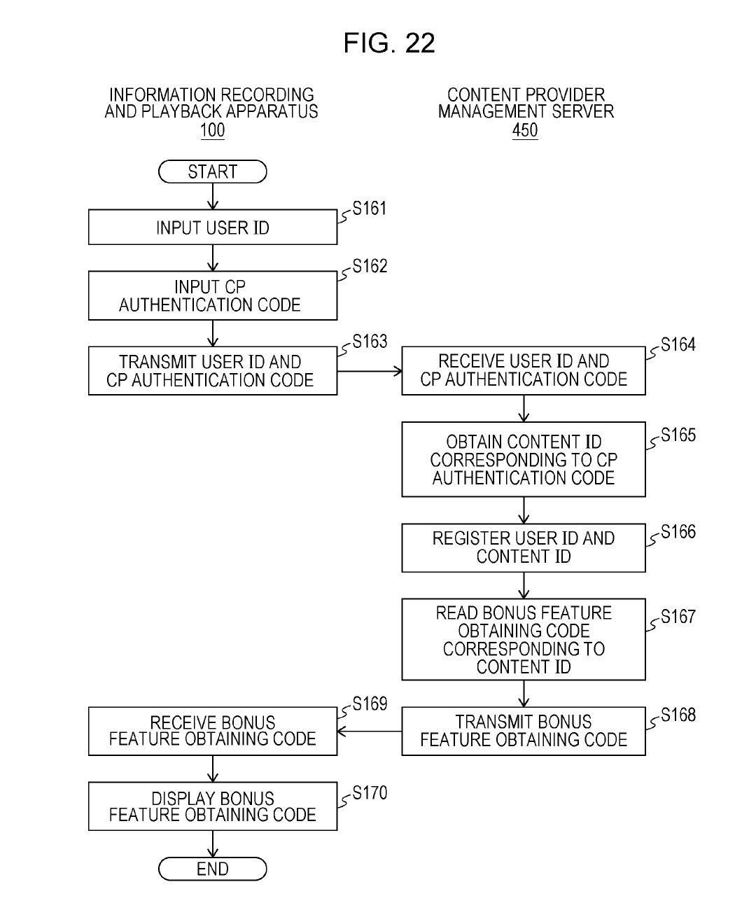

FIG. 22 is a flowchart illustrating an example of operations performed by the information recording and playback apparatus 100 and the content provider management server 450 according to the fourth embodiment.

First, in step S161, the input processing unit 116 of the information recording and playback apparatus 100 receives a user ID input by the user. The content provider management server 450 provides the user ID in advance, and the user ID is already registered in the content provider management server 450.

In step S162, the input processing unit 116 receives a CP authentication code input by the user. The CP authentication code is included in a package of the optical disc 310 to be copied.

In step S163, the communication control unit 114 transmits the user ID and the CP authentication code received by the input processing unit 116 to the content provider management server 450.

In step S164, the input processing unit 460 of the content provider management server 450 receives the user ID and the CP authentication code transmitted from the information recording and playback apparatus 100.

In step S165, the user registration unit 465 reads a content ID corresponding to the received CP authentication code from the CP authentication code management database 424.

In step S166, the user registration unit 465 associates the received user ID and the content ID read from the CP authentication code management database 424 with each other and registers the user ID and the content ID to the user/content information management region 470.

In step S167, the bonus feature obtaining code conversion unit 490 reads a bonus feature obtaining code corresponding to the read content ID from the bonus feature obtaining code management database 422.

In step S168, the bonus feature obtaining code output unit 495 transmits the bonus feature obtaining code read by the bonus feature obtaining code conversion unit 490 to the information recording and playback apparatus 100.

In step S169, the communication control unit 114 of the information recording and playback apparatus 100 receives the bonus feature obtaining code transmitted from the content provider management server 450.

In step S170, the system control unit 110 displays the bonus feature obtaining code received by the communication control unit 114 on the television set 500.

As a result of the above process, the user can obtain a bonus feature obtaining code and copy the content data stored in the optical disc 310 to another recording medium using the obtained bonus feature obtaining code.

Although the information recording and playback apparatus 100 receives a user ID and a CP authentication code and a bonus feature obtaining code is transmitted to the information recording and playback apparatus 100, the present disclosure is not limited to this. For example, a mobile device or a PC may receive a user ID and a CP authentication code, and a bonus feature obtaining code may be transmitted to the mobile device or the PC, instead.

### Fifth Embodiment

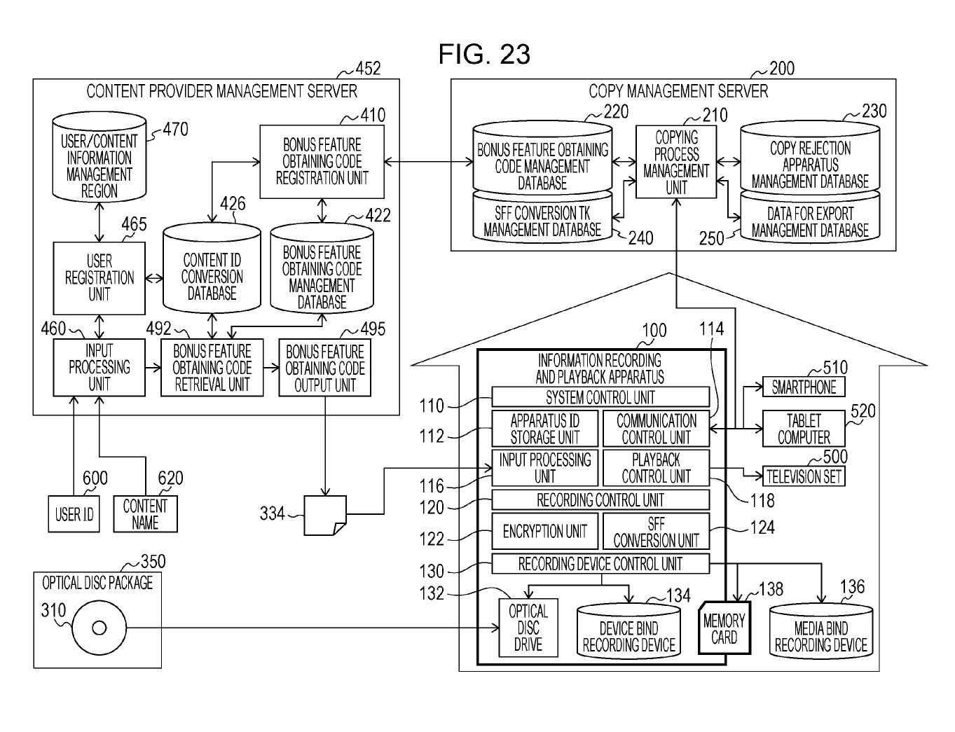

FIG. 23 is a diagram illustrating an overall configuration of a copy control system according to a fifth embodiment of the present disclosure. In the fifth embodiment, a bonus feature obtaining code is not included in a package of an optical disc. An online digital store managed by a content provider, a digital retailer, a rental company, or the like sells a right of copying, and a bonus feature obtaining code is provided for a user who has purchased the right of copying. As in FIG. 20, processing performed after the bonus feature obtaining code 334 is input to the information recording and playback apparatus 100 is the same as that according to the third embodiment.

The digital retailer can therefore sell a right to copy content data like ordinary digital content if the digital retailer obtains permission to sell the right to copy content data from the content provider.

The copy control system illustrated in FIG. 23 includes the information recording and playback apparatus 100, the copy management server 200, a content provider management server 452, the television set 500, and the smartphone 510.

The configuration of the content provider management server 452 of the copy control system illustrated in FIG. 23 is different from that of the content provider management server 450 of the copy control system illustrated in FIG. 20, but the configuration of the copy management server 200 and the information recording and playback apparatus 100 of the copy control system illustrated in FIG. 23 is the same as that of the information recording and playback apparatus 100 and the copy management server 200 of the copy control system illustrated in FIG. 20.

The content provider management server 452 includes the bonus feature obtaining code registration unit 410, the bonus feature obtaining code management database 422, a content ID conversion database 426, the input processing unit 460, the user registration unit 465, the user/content information management region 470, a bonus feature obtaining code retrieval unit 492, and the bonus feature obtaining code output unit 495.

The content ID conversion database 426 is used for storing content names and content IDs associated with each other.

The input processing unit 460 receives a user ID and a content name. The input processing unit 460 also receives a user ID and a content name through a network.

The bonus feature obtaining code retrieval unit 492 reads a bonus feature obtaining code corresponding to a content ID from the bonus feature obtaining code management database 422. The bonus feature obtaining code output unit 495 outputs the bonus feature obtaining code read by the bonus feature obtaining code retrieval unit 492.

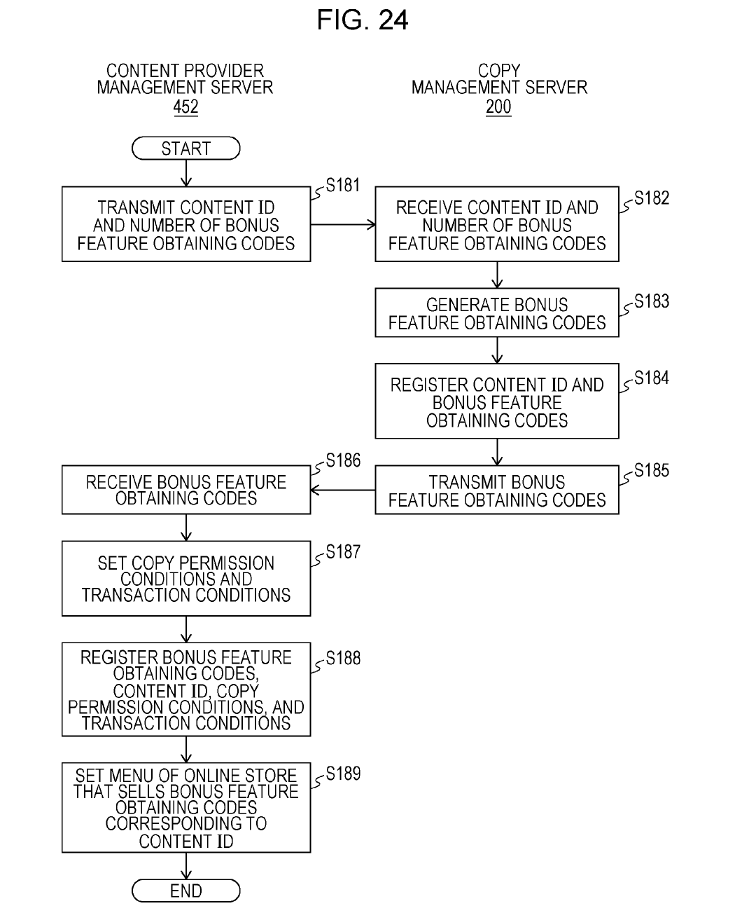

FIG. 24 is a flowchart illustrating an example of operations performed by the copy management server 200 and the content provider management server 452 according to the fifth embodiment.

Processing in steps S181 to S186 is the same as that in steps S31 to S36 illustrated in FIG. 7, and description thereof is omitted.

In step S187, the bonus feature obtaining code registration unit 410 sets a copy permission condition and a transaction condition for each content ID.

In step S188, the bonus feature obtaining code registration unit 410 registers the received bonus feature obtaining codes, the content ID, the copy permission conditions, and the transaction condition to the bonus feature obtaining code management database 422.

In step S189, the bonus feature obtaining code registration unit 410 sets a menu of an online store that sells the bonus feature obtaining codes corresponding to the registered content ID in accordance with the transaction condition.

As described above, in the copy control system according to the present embodiment, bonus feature obtaining codes are sold as in an ordinary electronic commerce or an online digital content store. If a bonus feature obtaining code is not included in a package of an optical disc or content data stored in a rented optical disc is copied, the price of copying of the content data can be collected, and a copying process in which a bonus feature obtaining code is used can be realized.

In the process illustrated in FIG. 24, the value of a right of copying becomes clear, and it is easy to reserve rights of owners of copyright. Since an ordinary online digital content store can sell bonus feature obtaining codes, a charging process need not be separately provided. Alternatively, an existing electronic marketplace may be committed to sell bonus feature obtaining codes. By selling bonus feature obtaining codes in an ordinary online digital content store, promotion of content and a price revision can be easily conducted. In addition, the user just purchases a bonus feature obtaining code and need not perform another purchase and transaction process. Consumer appliances may only have a function of inputting a bonus feature obtaining code. The copy management server 200 needs to issue a bonus feature obtaining code, but since a charging process is not necessary, the process can be simplified, and the copy management server 200 can be easily operated.

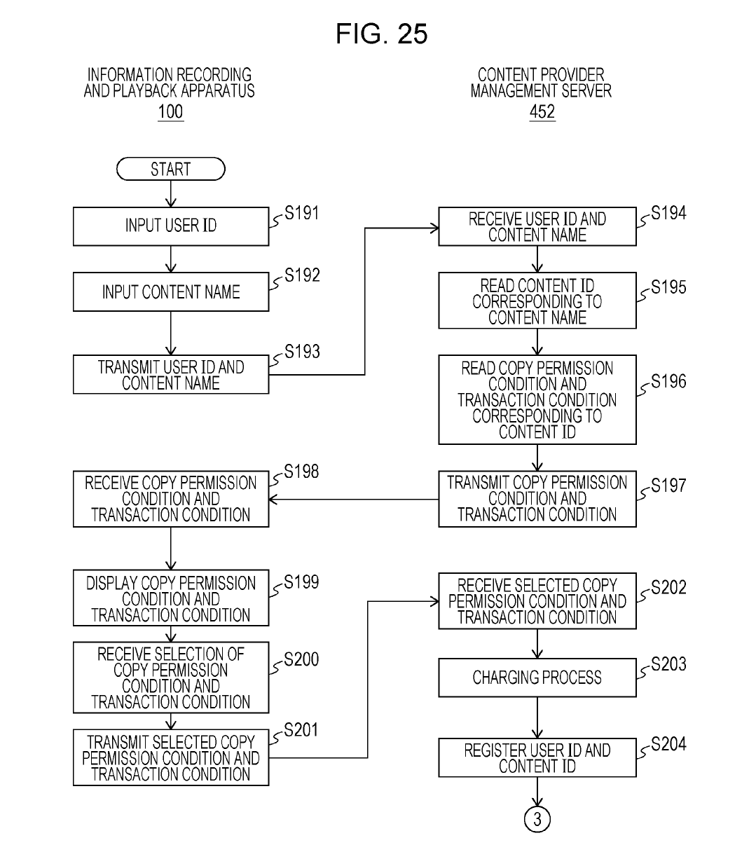

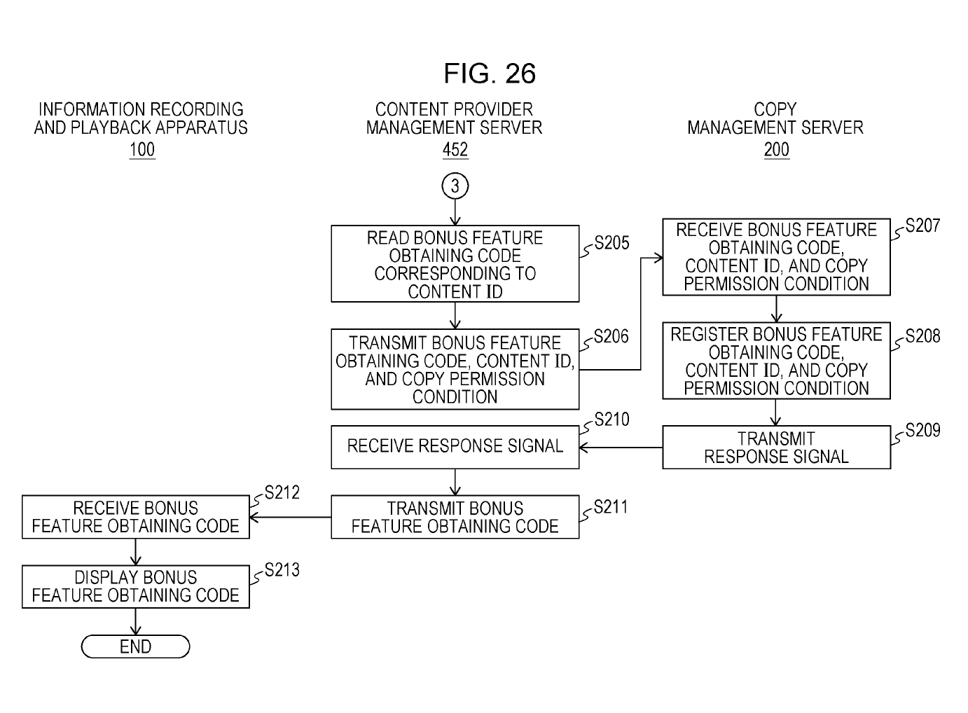

FIG. 25 is a first flowchart illustrating an example of operations performed by the information recording and playback apparatus 100, the copy management server 200, and the content provider management server 452 according to the fifth embodiment. FIG. 26 is a second flowchart illustrating the example of the operations performed by the information recording and playback apparatus 100, the copy management server 200, and the content provider management server 452 according to the fifth embodiment.

First, in step S191, the input processing unit 116 of the information recording and playback apparatus 100 receives a user ID input by the user. The content provider management server 452 provides the user ID in advance, and the user ID is already registered in the content provider management server 452.

In step S192, the input processing unit 116 receives a content name input by the user. The content name is the name of content stored in the optical disc 310 to be copied. The content name may be directly input, or may be selected from a plurality of options.

In step S193, the communication control unit 114 transmits the user ID and the content name received by the input processing unit 116 to the content provider management server 452.

In step S194, the input processing unit 460 of the content provider management server 452 receives the user ID and the content name transmitted from the information recording and playback apparatus 100.

In step S195, the user registration unit 465 reads a content ID corresponding to the received content name from the content ID conversion database 426.

In step S196, the bonus feature obtaining code retrieval unit 492 reads a copy permission condition and a transaction condition corresponding to the read content ID from the bonus feature obtaining code management database 422.

In step S197, the bonus feature obtaining code retrieval unit 492 transmits the read copy permission conditions and transaction condition to the information recording and playback apparatus 100.

In step S198, the communication control unit 114 of the information recording and playback apparatus 100 receives the copy permission condition and the transaction condition transmitted from the content provider management server 452.

In step S199, the system control unit 110 displays the copy permission condition and the transaction condition received by the communication control unit 114 on the television set 500.

In step S200, the system control unit 110 receives selection regarding the copy permission condition and the transaction condition. The user selects the copy permission condition (the bind method or the like) and the transaction condition (a credit card or the like).

In step S201, the communication control unit 114 transmits the selected copy permission condition and transaction condition to the content provider management server 452.

In step S202, the input processing unit 460 of the content provider management server 452 receives the copy permission condition and the transaction condition transmitted from the information recording and playback apparatus 100.

In step S203, the user registration unit 465 performs a charging process according to the received copy permission condition and transaction condition. That is, for example, the user registration unit 465 makes a transaction for a bonus feature obtaining code using a credit card selected by the user.

In step S204, the user registration unit 465 associates the received user ID and the content ID read from the content ID conversion database 426 with each other and registers the user ID and the content ID to the user/content information management region 470.

In step S205, the bonus feature obtaining code retrieval unit 492 reads a bonus feature obtaining code corresponding to the read content ID from the bonus feature obtaining code management database 422.

In step S206, the bonus feature obtaining code registration unit 410 transmits the bonus feature obtaining code read by the bonus feature obtaining code retrieval unit 492, the content ID, and the copy permission condition to the copy management server 200.

In step S207, the copying process management unit 210 receives the bonus feature obtaining code, the content ID, and the copy permission condition transmitted from the content provider management server 452.

In step S208, the copying process management unit 210 registers the received bonus feature obtaining code, content ID, and copy permission condition to the bonus feature obtaining code management database 220.

After registering the bonus feature obtaining code, the content ID, and the copy permission condition, the copying process management unit 210 transmits, in step S209, a response signal to the content provider management server 452.

In step S210, the bonus feature obtaining code registration unit 410 of the content provider management server 452 receives the response signal transmitted from the copy management server 200.

In step S211, the bonus feature obtaining code output unit 495 transmits the bonus feature obtaining code read by the bonus feature obtaining code retrieval unit 492 to the information recording and playback apparatus 100.

In step S212, the communication control unit 114 of the information recording and playback apparatus 100 receives the bonus feature obtaining code transmitted from the content provider management server 452.

In step S213, the system control unit 110 displays the bonus feature obtaining code received by the communication control unit 114 on the television set 500.

### Sixth Embodiment

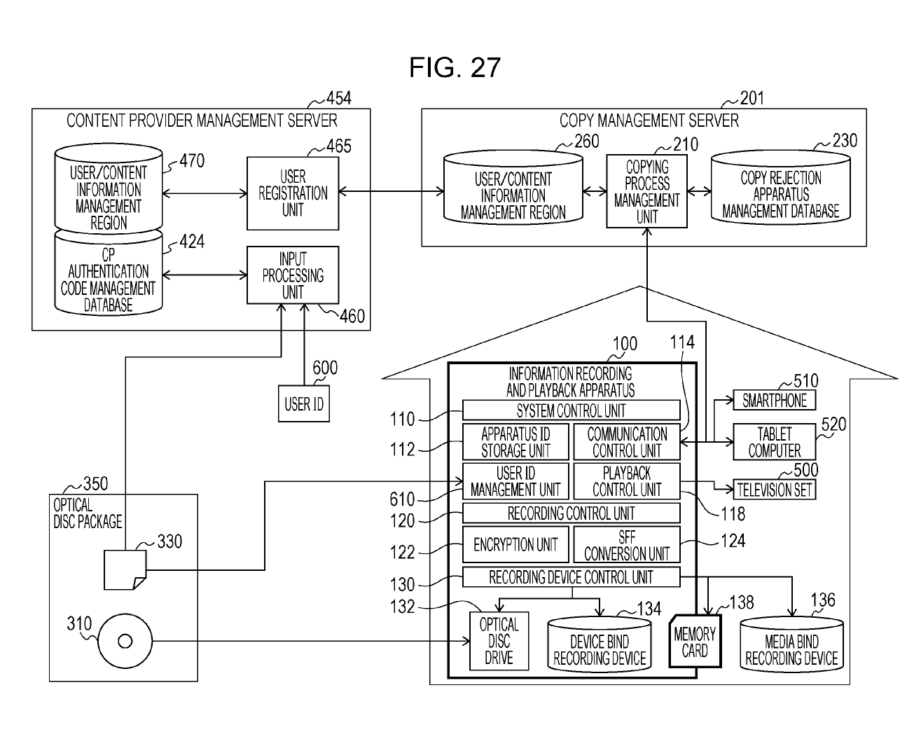

FIG. 27 is a diagram illustrating an overall configuration of a copy control system according to a sixth embodiment of the present disclosure. A basic process performed by the copy control system according to the sixth embodiment is the same as that performed by the copy control system illustrated in FIG. 16, but not a bonus feature obtaining code but a user ID 600 is input to the information recording and playback apparatus 100. Because an association of an apparatus ID and a user ID is stored in a copy management server 201 or a user ID is associated with and stored in the information recording and playback apparatus 100, a bonus feature obtaining code need not be input in each process. A right of copying can be associated with a user ID corresponding to a request from the information recording and playback apparatus 100, and the content data stored in the optical disc 310 can be copied. The content data can therefore be copied more easily through substantially the same operations as those in other embodiments.

The copy control system illustrated in FIG. 27 includes the information recording and playback apparatus 100, the copy management server 201, a content provider management server 454, the television set 500, and the smartphone 510.

The information recording and playback apparatus 100 includes the system control unit 110, the apparatus ID storage unit 112, the communication control unit 114, a user ID management unit 610, the playback control unit 118, the recording control unit 120, the encryption unit 122, the SFF conversion unit 124, the recording device control unit 130, the optical disc drive 132, and the device bind recording device 134.

The user ID management unit 610 receives the user ID 600 input by the user. The input user ID 600 may be stored in the user ID management unit 610.

The communication control unit 114 transmits an apparatus ID, the user ID and a content ID to the copy management server 201. The communication control unit 114 receives the user ID 600 for identifying the user and obtains the received user ID as the permission request code used in other embodiments.

The content provider management server 454 includes the CP authentication code management database 424, the input processing unit 460, the user registration unit 465, and the user/content information management region 470.

The input processing unit 460 receives the user ID 600 and a CP authentication code.

The CP authentication code management database 424 is used for storing content IDs and CP authentication codes associated with each other. The CP authentication code management database 424 is also used for storing content IDs and copy permission conditions associated with each other.

The user registration unit 465 associates the user ID 600 received by the input processing unit 460 and a content ID obtained on the basis of the CP authentication code received by the input processing unit 460 with each other and registers the user ID 600 and the content ID to the user/content information management region 470. The user registration unit 465 transmits the content ID, the user ID 600, and the copy permission condition to the copy management server 201. The user/content information management region 470 is used for storing user IDs and content IDs associated with each other.

The copy management server 201 includes the copying process management unit 210, a user/content information management region 260, and the copy rejection apparatus management database 230.

The user/content information management region 260 is used for storing combinations of content IDs and user IDs and copy permission conditions associated with each other.

The copying process management unit 210 receives the apparatus ID, the user ID 600, and the content ID transmitted from the information recording and playback apparatus 100. The copying process management unit 210 checks that a combination of the received content ID and user ID 600 is stored in the user/content information management region 260. The copying process management unit 210 then obtains a copy permission condition associated with the received content ID and transmits the obtained copy permission condition to the information recording and playback apparatus 100.

The copying process management unit 210 also obtains (receives) combinations of content IDs and user IDs and copy permission conditions associated with the combinations from a server managed by a content provider that manufactures optical discs (portable recording media). The copying process management unit 210 registers the obtained content IDs, user IDs, and copy permission conditions to the bonus feature obtaining code management database 220.

The copy management server 201 may also include the SFF conversion TK management database 240 and the data for export management database 250.

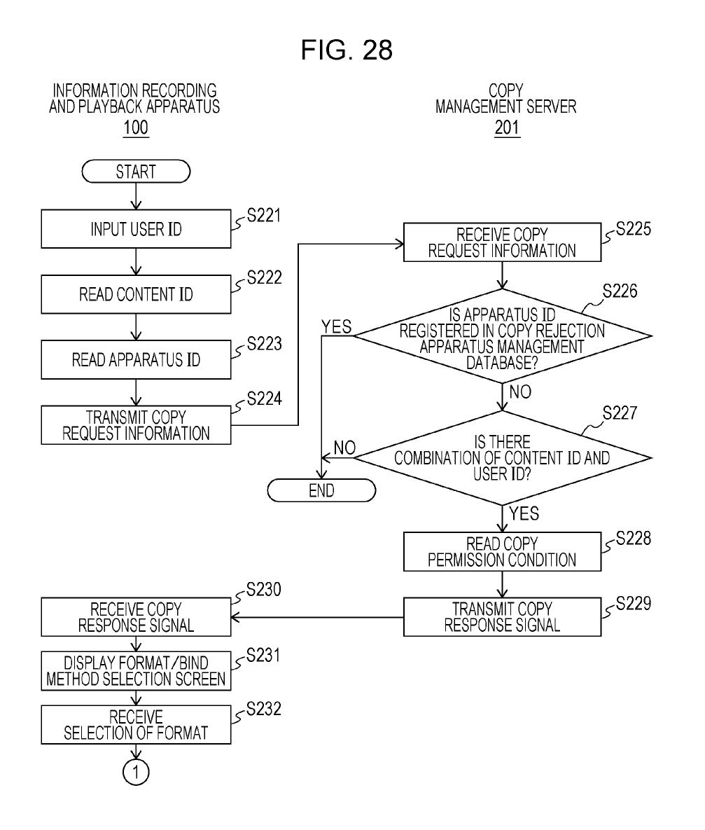

FIG. 28 is a flowchart illustrating an example of operations performed by the information recording and playback apparatus 100 and the copy management server 201 according to the sixth embodiment.

First, in step S221, the user ID management unit 610 of the information recording and playback apparatus 100 receives a user ID input by the user.

Processing in steps S222 and S223 is the same as that in steps S2 and S3 illustrated in FIG. 4, and description thereof is omitted.

In step S224, the communication control unit 114 transmits copy request information including the user ID, a content ID, and an apparatus ID to the copy management server 201.

Processing in steps S225 and S226 is the same as that in steps S5 and S6 illustrated in FIG. 4, and description thereof is omitted.

If the copying process management unit 210 determines that the apparatus ID is not registered in the copy rejection apparatus management database 230 (NO in step S226), the copying process management unit 210 determines in step S227 whether the combination of the content ID and the user ID included in the received copy request information is registered in the user/content information management region 260. If the copying process management unit 210 determines that the combination of the content ID and the user ID is not registered in the user/content information management region 260 (NO in step S227), the copying process management unit 210 ends the process. At this time, the copying process management unit 210 may transmit, to the information recording and playback apparatus 100, information indicating that the user ID is not registered. Upon receiving the information, the information recording and playback apparatus 100 may display a screen indicating that copying cannot be performed because the user ID is not registered.

On the other hand, if the copying process management unit 210 determines that the combination of the content ID and the user ID is registered in the user/content information management region 260 (YES in step S227), the copying process management unit 210 reads, in step S228, a copy permission condition corresponding to the content ID from the user/content information management region 260. According to the copy permission condition, the user needs to select one of the three predetermined bind methods, namely the device bind method, the media bind method, and the domain bind method, and the file format of content data obtained as a result of copying.

Processing in steps S229 to S232 is the same as that in steps S49 to S52 illustrated in FIG. 11, and description thereof is omitted. Processing performed after step S232 is the same as that in steps S53 to S66 illustrated in FIG. 12, and description thereof is omitted.

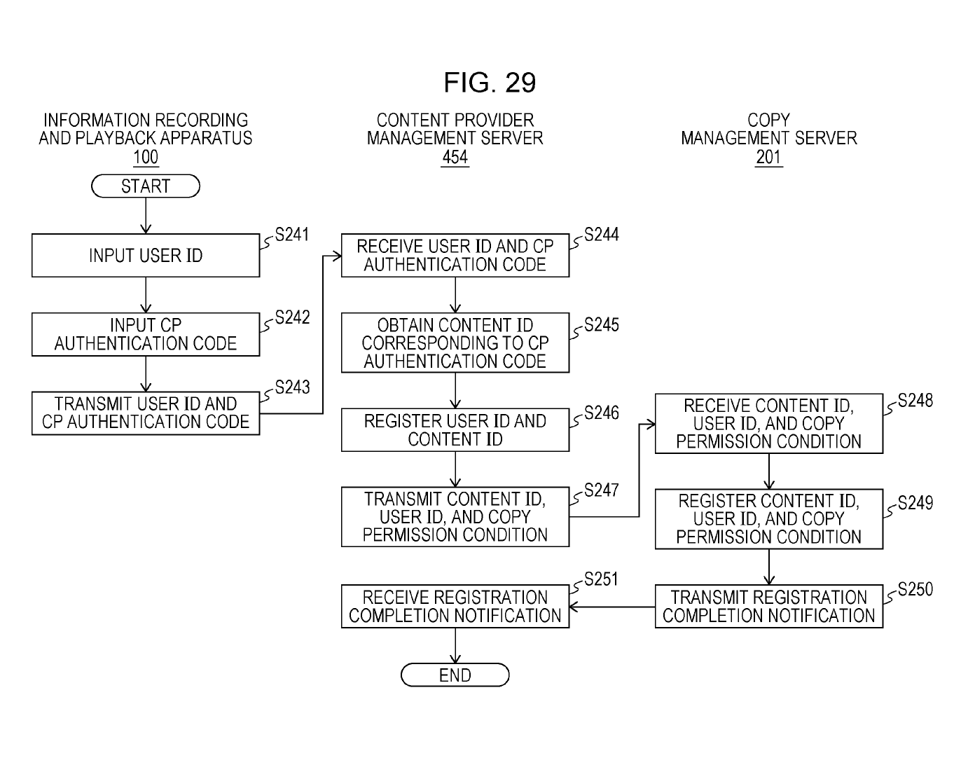

FIG. 29 is a flowchart illustrating an example of operations performed by the information recording and playback apparatus 100, the copy management server 201, and the content provider management server 454 according to the sixth embodiment.

First, in step S241, the user ID management unit 610 of the information recording and playback apparatus 100 receives a user ID input by the user. The system control unit 110 displays, on the television set 500, a user ID registration screen for registering a user ID to the copy management server 201. In the user ID registration screen, the user is asked to input a user ID.

In step S242, the user ID management unit 610 receives a CP authentication code input by the user. The CP authentication code is included in the package of the optical disc 310 to be copied.

In step S243, the communication control unit 114 transmits the user ID and the CP authentication code received by the user ID management unit 610 to the content provider management server 454.

In step S244, the input processing unit 460 of the content provider management server 454 receives the user ID and the CP authentication code transmitted from the information recording and playback apparatus 100.

In step S245, the user registration unit 465 reads a content ID corresponding to the received CP authentication code from the CP authentication code management database 424.

In step S246, the user registration unit 465 associates the received user ID and the content ID read from the CP authentication code management database 424 with each other and registers the user ID and the content ID to the user/content information management region 470.

In step S247, the user registration unit 465 reads a copy permission condition corresponding to the content ID from the CP authentication code management database 424 and transmits the content ID, the user ID, and the copy permission condition to the copy management server 201.

In step S248, the copying process management unit 210 of the copy management server 201 receives the content ID, the user ID, and the copy permission condition transmitted from the content provider management server 454.

In step S249, the copying process management unit 210 registers the received content ID, user ID, and copy permission condition to the user/content information management region 260.

After registering the content ID, the user ID, and the copy permission condition, the copying process management unit 210 transmits, in step S250, a registration completion notification to the content provider management server 454.

In step S251, the user registration unit 465 of the content provider management server 454 receives the registration completion notification transmitted from the copy management server 201.

Although the information recording and playback apparatus 100 receives a user ID and a CP authentication code in the sixth embodiment, the present disclosure is not limited to this. A mobile device or a PC, for example, may receive a user ID and a CP authentication code.

In each of the first to sixth embodiments, the copy control system enables a purchaser of an optical disc to play back content data not only using the information recording and playback apparatus but also using a home server or a mobile device without deteriorating image quality. In addition, a content provider can appropriately collect customer information using a platform for digital distribution. A small content provider need not prepare its own server.

By introducing a charging process for purchase of a bonus feature obtaining code, the information recording and playback apparatus and the management server need not perform a charging process. A content provider or a digital retailer performs the charging process before the purchaser of the optical disc performs copying. The management server or the information recording and playback apparatus receives only a result of the charging process without receiving personal information and information regarding a price, a credit card, and the like. Content data stored in the optical disc can therefore be copied through simple user action.

More specifically, the price of an optical disc package sold includes the price of a right to copy the content data stored in the optical disc. A bonus feature obtaining code is used as a proof of the transaction. In this case, the information recording and playback apparatus includes only an interface for inputting a bonus feature obtaining code. By transmitting the input bonus feature obtaining code, a content ID (for example, the name of content) of the optical disc, and an apparatus ID to the management server, the legitimacy of the information recording and playback apparatus and the bonus feature obtaining code can be confirmed, and a copy permission condition can be identified. The content data stored in the optical disc can therefore be copied.

The management server can register combinations of content IDs and bonus feature obtaining codes and copy permission conditions (the number of copies, the file format of content data obtained as a result of copying, DRM, a digital retailer, or the like) to the database in accordance with a request from the content provider and manage the combinations and the copy permission conditions. If the information recording and playback apparatus makes an inquiry, the database can reply to the information recording and playback apparatus as to whether copying is permitted or not and, if the copying is permitted, transmit a copying permission condition. The information recording and playback apparatus can also learn which piece of content a user of a certain apparatus has copied, without directly managing personal information.

It is sufficient that the content provider register combinations of bonus feature obtaining codes included in optical disc packages and content IDs and copy permission conditions to the management server. Even a small content provider can therefore adopt this scheme.

Bonus feature obtaining codes need not necessarily be included in optical disc packages as paper media. A user who has purchased, from a digital retailer, an optical disc package for which a right of copying is not provided can therefore purchase the right to copy content data stored in the optical disc from the digital retailer to obtain a bonus feature obtaining code. In this case, by inputting the obtained bonus feature obtaining code to the information recording and playback apparatus, the user can copy the content data stored in the optical disc.

Similarly, if a user likes image content stored in a rented optical disc, the user can purchase a right to copy the image content in an online digital store of an optical disc rental company to obtain a bonus feature obtaining code, insofar as the optical disc rental company is permitted to do so by a content provider.

In addition, if a user has purchased a right of copying in an online store of a digital retailer or an optical disc rental company and permitted the digital retailer or the optical disc rental company to associate an ID of the digital retailer or the optical disc rental company, a user ID of the management server, and a user ID of the information recording and playback apparatus with one another, the user need not input a bonus feature obtaining code. Just by inputting the user ID, the user can copy content data stored in an optical disc more easily using the information recording and playback apparatus because a copy permission condition is set through the management server.

The information recording and playback apparatus can achieve a function of copying content data stored in an optical disc through simple communication between a user interface for inputting a simple bonus feature obtaining code or user ID and the management server, without performing a charging process. A manufacturing cost of the information recording and playback apparatus can therefore be reduced, thereby making the information recording and playback apparatus more available. Since the copy function can be realized with a simple interface, a new value can be added to the information recording and playback apparatus.

The management server can manage simple bonus feature obtaining codes or user IDs and content and achieve a function of copying content data stored in an optical disc through simple communication with the information recording and playback apparatus. An installation cost and an operation cost of the management server can therefore be reduced, thereby making the copy function more available.

A content provider or a digital retailer need not develop a dedicated charging process. It is sufficient that the content provider or the digital retailer sell a bonus feature obtaining code or a right of copying to a user in an online store generally used or an online digital content store and share sale conditions with the management server as necessary. The copy function, which is a new value added to optical discs, can be provided relatively easily and cheaply, thereby making the copy function more available.

Since a general online store can be used, a content provider or a digital retailer can arbitrarily conduct promotion of content, price setting, and a price revision regardless of the management server.

In addition, since the copy function can be provided under a copy permission condition specified by an owner of copyright just by registering a bonus feature obtaining code or a user ID to the information recording and playback apparatus or the management server, various business models can be arbitrarily constructed.

Since the user need not perform a cumbersome charging process including input of a credit card number and worry about security of the information recording and playback apparatus, the user can use the copy function without worry. Since the user pays for the copy function when the user purchases an optical disc package or in an online store of a digital retailer or the like, the user can easily use the copy function without worry. The copy function according to the above embodiments offers higher image quality than in common digital copy, and the user need not download content data through a network. The user can therefore use the copy function according to the above embodiments when the desiring to view content in any place with high image quality and use common digital copy when desiring to casually view content on a PC or a mobile device with low image quality. The copy function according to the above embodiments can be used along with common digital copy.

An information apparatus, a management server, and a copy control method in the present disclosure are capable of easily copying content data stored in a portable recording medium to another recording medium using a permission request code for requesting permission to copy content data. The information apparatus, the management server, and the copy control method are effective as an information apparatus, a management server, and a copy control method for copying content data stored in a portable recording medium to another recording medium.

What is claimed is:

1. An information apparatus that copies content data stored in a portable recording medium to another recording medium, the information apparatus comprising:
an obtainer that obtains a permission request code for requesting permission to copy the content data;
a reader that reads, from the portable recording medium, content identification information for identifying the content data, the content identification information being stored in the portable recording medium;
a transmitter that transmits the permission request code and the content identification information to a management server;
a receiver that receives, from the management server, a copy permission condition that is associated with a combination of the permission request code and the content identification information and that indicates a condition under which the content stored in the portable recording medium is copied to the other recording medium; and
a copy processor that copies the content data stored in the portable recording medium to the other recording medium in accordance with the copy permission condition.

2. The information apparatus according to claim 1,
wherein the obtainer receives user identification information for identifying a user and obtains the received user identification information as the permission request code.

3. The information apparatus according to claim 1,
wherein the copy permission condition includes a condition that a file format of content data obtained as a result of copying be selected from a plurality of predetermined file formats, and
wherein the copy processor receives one of the plurality of file formats selected by the user and copies the content data in the received file format.

4. The information apparatus according to claim 3,
wherein the plurality of file formats include a transport stream format and an MP4 format.

5. The information apparatus according to claim 1,
wherein the copy permission condition includes a first condition under which only copying to a certain device is permitted, a second condition under which only copying to a certain type of recording medium is permitted, and a third condition under which only copying to a certain domain in a network is permitted, and
wherein the copy processor receives the first condition, the second condition, or the third condition selected by the user and copies the content data under the first condition, the second condition, or the third condition selected by the user.

6. The information apparatus according to claim 1,
wherein the copy processor receives a bind method selected by the user and copies the content data using the bind method,
wherein the bind method is a device bind method in which only copying to a certain device is permitted, a media bind method in which only copying to a certain type of recording medium is permitted, or a domain bind method in which only copying to a certain domain in a network is permitted,
wherein the transmitter transmits a result of copying of the content data performed by the copy processor, and
wherein the result of the copying includes information indicating the bind method used by the copy processor for copying the content data.

7. A management server communicably connected to an information apparatus that copies content data stored in a portable recording medium to another recording medium, the management server comprising:
a copy permission condition storage used for storing a combination of content identification information for identifying the content data and a permission request code for requesting permission to copy the content data and a copy permission condition indicating a condition under which the content data stored in the portable recording medium is copied to the other recording medium, the combination and the copy permission condition being associated with each other;
a receiver that receives the permission request code and the content identification information from the information apparatus;
a reader that reads, from the copy permission condition storage, the copy permission condition associated with the combination of the permission request code and the content identification information received from the information apparatus; and
a transmitter that transmits the read copy permission condition to the information apparatus.

8. The management server according to claim 7,
wherein the permission request code includes user identification information for identifying a user.

9. The management server according to claim 7, further comprising:
a generator that generates the permission request code managed in association with the content identification information;
a permission request code register that registers the generated permission request code to the copy permission condition storage; and
a provider that provides the permission request code and the content identification information for a server managed by a content provider that manufactures the portable recording medium.

10. The management server according to claim 8, further comprising:
an obtainer that obtains the combination of the content identification information and the user identification information and the copy permission condition associated with the combination from the server managed by the content provider that manufactures the portable recording medium; and
a copy permission condition register that registers, to the copy permission condition storage, the content identification information, the user identification information, and the copy permission condition obtained by the obtainer.

11. The management server according to claim 7, further comprising:
a result receiver that receives, from the information apparatus that has transmitted the copy permission condition, a copy result including information indicating a bind method used for copying the content data; and
an abnormality transmitter that notifies the information apparatus of an abnormality if the bind method indicated by the received information is not permitted by the copy permission condition associated with the combination of the permission request code and the content identification information.

12. A copy control method for copying content data stored in a portable recording medium to another recording medium, the copy control method comprising:
obtaining a permission request code for requesting permission to copy the content data;
reading, from the portable recording medium, content identification information for identifying the content data, the content identification information being stored in the portable recording medium;
transmitting the permission request code and the content identification information to a management server;
receiving, from the management server, a copy permission condition that is associated with a combination of the permission request code and the content identification information and that indicates a condition under which the content stored in the portable recording medium is copied to the other recording medium; and
copying the content data stored in the portable recording medium to the other recording medium in accordance with the copy permission condition.

13. The copy control method according to claim 12,
wherein, in the obtaining, user identification information for identifying a user is received, and the received user identification information is obtained as the permission request code.

14. The copy control method according to claim 12,
wherein the copy permission condition includes a condition that a file format of content data obtained as a result of copying be selected from a plurality of predetermined file formats, and
wherein, in the copying, one of the plurality of file formats selected by the user is received, and the content data is copied in the received file format.

15. The copy control method according to claim 14,
wherein the plurality of file formats include a transport stream format and an MP4 format.

16. The copy control method according to claim 12,
wherein the copy permission condition includes a first condition under which only copying to a certain device is permitted, a second condition under which only copying to a certain type of recording medium is permitted, and a third condition under which only copying to a certain domain in a network is permitted, and
wherein, in the copying, the first condition, the second condition, or the third condition selected by the user is received, and the content data is copied under the first condition, the second condition, or the third condition selected by the user.

17. The information apparatus according to claim 1,
wherein the copy processor receives a bind method selected by the user and copies the content data using the bind method,
wherein the bind method is a device bind method in which only copying to a certain device is permitted, a media bind method in which only copying to a certain type of recording medium is permitted, or a domain bind method in which only copying to a certain domain in a network is permitted, and
wherein the transmitter transmits information indicating the bind method to the management server.
